(19) United States
(12) Patent Application Publication
(10) Pub. No.: US 2022/0053683 A1
(43) Pub. Date: Feb. 24, 2022

(54) APPARATUS FOR ATTACHMENT TO A TRACTOR

(71) Applicant: Bourgelat Pty Ltd, Eltham (AU)

(72) Inventor: Duncan Geoffrey BUCKNELL, Eltham (AU)

(21) Appl. No.: 17/408,635

(22) Filed: Aug. 23, 2021

(30) Foreign Application Priority Data
Aug. 22, 2020 (AU) AU2020903008
Nov. 16, 2020 (AU) AU2020904205

(51) Int. Cl. A01B 59/043; B60D 1/14; A01B 63/10; E02F 3/34; E02F 9/22

(52) U.S. Cl. CPC A01B 59/043; B60D 1/141; E02F 9/2275; E02F 3/3414; A01B 63/10

(57) ABSTRACT

An apparatus for attachment to a tractor the apparatus comprising a primary implement and at a first end, connections suitable to connect to the three point linkage of the tractor and at a second end, connections suitable to connect to the three point hitch points of a secondary implement.

### CROSS-REFERENCE TO RELATED APPLICATIONS

The present patent application claims priority to Australian patent applications AU2020903008 filed Aug. 22, 2020 and AU2020904205 filed Nov. 16, 2020, all of which are incorporated herein by reference in their entirety.

### BACKGROUND OF THE INVENTION

Utility tractors are used widely for various jobs around farms. They tend to be in the small to medium size category and various implements and attachments can be added to them to provide additional functionality as needed.

Typically implements can be added on the rear of the utility tractor by connecting to a three point linkage, to the rotary power take off (PTO) mechanism if power is required to use the implement and to the hydraulic outlets if hydraulics are also required for the implement. Some implements, such as a carry all, or certain hay handling equipment or tow ball attachments etc do not need the PTO. However others do, for example slashers, mowers, spreaders, rotary rakes, chippers, etc. Some implements also require hydraulic connections, such as hay bale or silage handling equipment, post hole diggers, seeders, some grader blades, some harrows, backhoes, etc.

Many times a land owner will want to use a utility tractor for multiple jobs at once or within a short period or at a similar area on the farm and so may wish to do so without having to return to the tractor storage area on the farm to swap over implements. There is currently no easy solution to this problem. Similarly, many times a land manager will have to take multiple vehicles to a location or use the tractor to tow a trailer to the location and then return for an implement also needed at that location before commencing work. Despite the fact that the three point linkage was invented in the 1920's, to the best knowledge of the inventor, there is currently no workable solution to these problems.

The reference to any prior art in this specification is not, and should not be taken as, an acknowledgement or any form of suggestion that the prior art forms part of the common general knowledge. The reference to any prior art in this specification is not, and should not be taken as, an acknowledgement or any form of suggestion that the prior art forms part of the common general knowledge.

### SUMMARY OF THE INVENTION

According to a first aspect of the invention, there is provided an apparatus for attachment to a tractor the apparatus comprising a primary implement and at a first end, connections suitable to connect to the three point linkage of the tractor and at a second end, connections suitable to connect to the three point hitch points of a secondary implement. In some embodiments, the primary implement comprises a platform for carrying agricultural tools or equipment.

As used herein, the term ‘primary implement’ refers to the implement which is part of the apparatus according to the invention and therefore connected via the first end of the apparatus to the tractor. The term ‘secondary’ implement’ refers to an implement which is connected to the second end of the apparatus according to the invention.

Some embodiments of the invention further comprise a power take-off extension extending from the first end to the second end to enable transfer of rotational force from the power take off, of the tractor through to the secondary implement. In some of the embodiments which comprise a power-take off extension, the power take off extension comprises a housing, and an attachment at each end for connection to, at the first end, the tractor power take-off for example, via a first PTO drive shaft attachment and at the second end the secondary implement power take off receiver for example via a second PTO drive shaft attachment. The power take-off extension may be located in any suitable position on the apparatus according to the invention, but in some preferred embodiments it is located underneath the apparatus of the invention for example underneath the primary implement.

In some embodiments of the invention, there is further provided a stabiliser which comprises one or more of a wheel or a stand or one or more legs. The stabiliser may also be releasably fixed to the underside of the apparatus so that it can be removed when not required. It may also comprises a hinge mechanism so that it is able to be folded up out of the way.

The connections of the apparatus of the invention may in some embodiments comprises a coupler to facilitate the connection of the tractor three-point linkage to the implement.

In another aspect of the invention, there is provided a kit of parts for retrofitting to a primary implement to manufacture an apparatus for attachment to a tractor, the kit comprising: an upper link, two lower links, two side stabiliser bars, and a housing comprising a PTO extension and attachment points for attachment of the housing to a frame of the primary implement.

One aspect of the invention provides an apparatus for attachment to a utility tractor, the apparatus having a first end and a second end and comprising: a frame; a primary implement; at the first end, an upper hitch point and two lower hitch points for connecting to the three point linkage of a tractor; at the second end, a three point linkage for attachment to three point hitch points of a secondary implement, the three point linkage welded or mechanically fastened to the frame so as to support the weight of and use of a secondary implement, and the three point linkage comprising an upper link and two lower links.

The frame of the apparatus according to certain aspects of the invention is the part of the apparatus to which is fixed (for example by welding or mechanical means) at least one of (a) the connections suitable to connect to the three point linkage of the tractor (such as three point hitch points) and/or (b) the connections suitable to connect to the three point hitch points of a secondary implement (such as a three point linkage or a coupler) or both. As such, the frame may in fact pre-exist in a currently known primary implement if it is possible to so attach one or both of these connections. It is intended that embodiments to which such connections are directly attached to a pre-existing type of primary implement are encompassed within the scope of the present invention.

Throughout this specification (including any claims which follow), unless the context requires otherwise, the word ‘comprise’, and variations such as ‘comprises’ and ‘comprising’, will be understood to imply the inclusion of a stated integer or step or group of integers or steps but not the exclusion of any other integer or step or group of integers or steps.

### BRIEF DESCRIPTION OF THE DRAWINGS

FIG. 1 is a side perspective view of an embodiment of the invention comprising a carry-all as the primary implement.

FIG. 2 is a side perspective view of an embodiment of the invention comprising a carry-all as the primary implement.

FIG. 3 is a perspective view of a PTO drive shaft attachment.

FIG. 4 is a side perspective view of an embodiment of the invention comprising a carry-all with additional hydraulic lift as the primary implement.

FIG. 5 is a perspective view from underneath of an embodiment of the invention comprising a carry-all as the primary implement with foldable support wheels.

FIG. 6 is a side perspective view of an embodiment of the invention comprising a carry-all as the primary implement with foldable support wheels.

FIG. 7 is a side perspective view of an embodiment of the invention comprising a carry-all in the shape of a pick-up truck or ute tray as the primary implement.

FIG. 8 is a side perspective view of an embodiment of the invention comprising a covered carry-all as the primary implement.

FIG. 9 is a side perspective view of an embodiment of the invention comprising a carry-all with tool box as the primary implement.

FIG. 10 is a side perspective view of an embodiment of the invention comprising a grader blade as the primary implement.

FIG. 11 is a side perspective view of an embodiment of the invention comprising a carry-all with toolbox as the primary implement and attached via a three point linkage to a chipper as the secondary implement.

FIG. 12 is a side perspective view of an embodiment of the invention comprising a carry-all with toolbox as the primary implement and attached via a three point linkage to a slasher as the secondary implement.

FIG. 13 depicts an example kit of parts for retrofitting, for example to a carry-all to manufacture an apparatus according to the invention.

FIGS. 14A and 14B are side perspective views of a typical three-point linkage hitch from an apparatus according to the invention (14A) and the hitch points on a secondary implement (14B).

FIGS. 15A and 15B are schematics depicting preferred dimensions for three point linkages on apparatuses of the invention.

FIG. 16 is a side view of a three point linkage on an apparatus of the invention.

FIGS. 17A and 17B comprise side views of two alternative lower hitch points for an apparatus of the invention.

FIG. 18 is a rear view schematic depicting preferred dimensions for certain embodiments for three point linkages mounted on an apparatus of the invention.

FIG. 19 is a rear view schematic depicting preferred dimensions for certain embodiments for three point linkages mounted on an apparatus of the invention.

FIG. 20 is a plan view schematic depicting preferred dimensions for certain embodiments for three point linkages mounted on an apparatus of the invention.

FIG. 21 is a side view schematic depicting preferred dimensions for certain embodiments for three point linkages mounted on an apparatus of the invention.

### DETAILED DESCRIPTION OF EXAMPLE EMBODIMENTS

It is convenient to describe the invention herein in relation to certain preferred embodiments. However, the invention is applicable to a wide range of embodiments and it is to be appreciated that other constructions and arrangements are also considered as falling within the scope of the invention.

As an example, the illustrations and descriptions herein sometimes refer to a three point linkage on the rear of a tractor. However, some modern tractors may have a three point linkage on the front of the tractor and some also have a PTO drive on the front of the tractor. The present invention is equally applicable to such front mounted three-point linkages and PTO drives as it is to those mounted on the rear of the tractor.

As a further example, a number of the embodiments described herein are variations on a theme based on carry-all type implements as the primary implement, however it will be appreciated that the invention may comprise many other types of implements that do not need the PTO drive which can pass through and be connected to the secondary implement on the second side of the apparatus of the invention. Examples may include, a grader blade, bed former, a box blade scraper, dirt scoop, harrows, a ripper, a rotary hoe, a plough, a finishing mower, a flail mower, landscape rakes, a spreader, an s-tine cultivator, a tillage implement, hay handling implements and so on.

Various modifications, alterations, variations and or additions to the construction and arrangements described herein are also considered as falling within the ambit and scope of the present invention.

The invention will first be described in general terms in order to demonstrate examples of the types of uses to which it can be put. More detail about certain dimensions and preferred requirements for certain embodiments will then be set out.

The following terms have the following means within this document:
Linkage: combination of one upper link and two lower links, each articulated to either (a) the tractor or (b) an apparatus of the invention (as the context dictates) and either (a) the apparatus of the invention and (b) a secondary implement at the opposite end, in order to connect: (a) the apparatus of the invention to the tractor; or (b) the secondary implement to the apparatus of the invention (as the context dictates).
Hitch point: articulated connection between link and implement.
Link point: articulated connection between link and either the tractor or the apparatus of the invention as the context dictates.
Three-point hitch coupler/coupler/implement coupler: device which facilitates the connection of a three-point linkage to the either the apparatus of the invention or to the secondary implement, as the context dictates.
Narrow hitch: standard hitch in all dimensions except for the lower hitch point span, which is that of the next smallest category. (Eg. A category 3N hitch can also be a category 2 hitch in all dimensions excepting the upper and lower hitch point pin diameters, which are category 3.

According to one aspect of the invention there is provided an apparatus for attachment to a tractor comprising a primary implement and at a first end, connections suitable to connect to the three point linkage of the tractor and at a second end, connections suitable to connect to the three point hitch points of a secondary implement. In this specification, a primary implement is the implement which forms part of the apparatus of the invention and a secondary implement is an implement which can be attached to the second side of an apparatus of the invention via the three point linkage.

Connectors for three point linkage systems on the rear of tractors are known and modifications of them suitable for the apparatus of the invention are depicted in the figures herein. It should be noted that a connector suitable to connect to a three point hitch or linkage may also be a coupler which is a device which facilitates the connection of tractor three-point linkage to an implement. In some instances, such couplers enable the land manager to hitch and unhitch without leaving the tractor operator's seat. Suitable examples of couplers may for example include: U frame couplers, A frame couplers, link couplers, and bar couplers.

Some embodiments of the invention comprise a power take off extension which enables transfer of rotational power from the power take off from the tractor through to the secondary implement. Such an extension is preferably suitably housed so as to reduce risk of damage from the rotating PTO shaft. In some embodiments the PTO extension shaft may be placed underneath the primary implement (for example if it is a carry-all), but it may be placed at any suitable position which enables the primary and secondary implements to function as required.

Some embodiments of the invention further comprise a stabiliser for the primary implement which may for example be a wheel or a stand or one or more legs. Such stabilisers are preferably able to be folded up out of the way or removed when not required. Wheels used as part of a stabiliser are preferably able to swivel to ensure they do not drag when the tractor changes direction etc.

In some embodiments the secondary implement is fixed relative to the primary implement and so can not move relative to it. In some embodiments, limited movement, for example lateral is possible. In some embodiments the secondary implement may move relative to the primary implement passively (for example whilst traversing a slope etc if it has its own wheels), but not actively (ie under power). In some embodiments the secondary implement may be raised or lowered relative to the primary implement. This may be effected by any suitable means, for example hydraulics, for example by hydraulic arms attached to lower links forming part of the three point linkage.

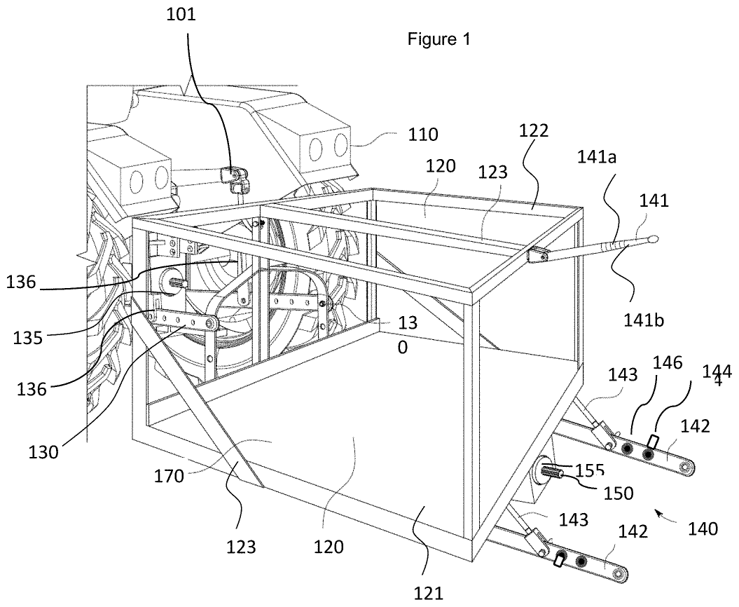

FIG. 1 is a side perspective view of an embodiment of the invention comprising a carry-all as the primary implement. FIG. 1 depicts the rear of a typical tractor 110, with an apparatus of the invention comprising a primary implement which is a carry-all 120 attached via tractor three point linkage upper link 101 and lower links 130. Lower links 130 are attached to lift rods 136 which use the hydraulic power of the tractor to raise and lower the lower links and thereby the attached primary implement. Tractor 110 also has a power take off (PTO) drive (or stub shaft) 135.

Apparatus 120 comprises a carry all as primary implement and therefore comprises a platform 121, frame elements 122, brace 123 and three point linkage attachment at the rear shown generally at 140. Three point linkage 140 on apparatus 120 comprises upper link 141 and lower links 142 and stabiliser bars 143 to restrict lateral movement of lower links 142 in use. Lower links 142 are adjustable in length, in this case by telescopic movement of two components and a series of holes 146 and pin 144 which is used as a stopper through holes in each component at a selected length. Similarly upper link 141 is adjustable in length, in this instance by the depicted threaded area 141a about which the distal section 141b of link 141 is rotated to shorten or lengthen the overall length of link 141. There are many other simple ways to enable adjustability of the length of the upper and lower links of the three point linkages of the invention.

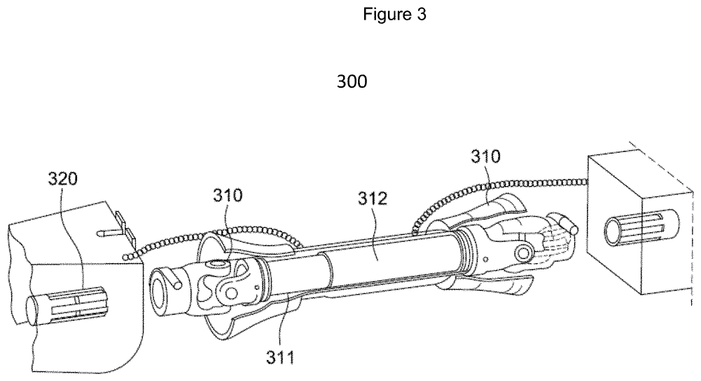

In FIG. 1, apparatus 120 is not attached to PTO drive 135 of tractor 110. However, a PTO drive shaft attachment can be readily fitted between PTO drive 135 and a complementary attachment on the PTO drive on apparatus 120 (not shown). This would have the effect of enabling rotational force from tractor PTO drive 135 to pass through to apparatus PTO drive 155 at the second end of the apparatus and therefore enable operation of any PTO drive elements of a secondary implement attached thereto via apparatus PTO drive output 50. Thus, in order for a secondary implement to be powered by the PTO drive of the tractor, a user must connect a first PTO drive shaft attachment between the tractor and the apparatus of the invention, and then a second PTO drive shaft attachment between the apparatus of the invention and the secondary implement. See FIG. 3.

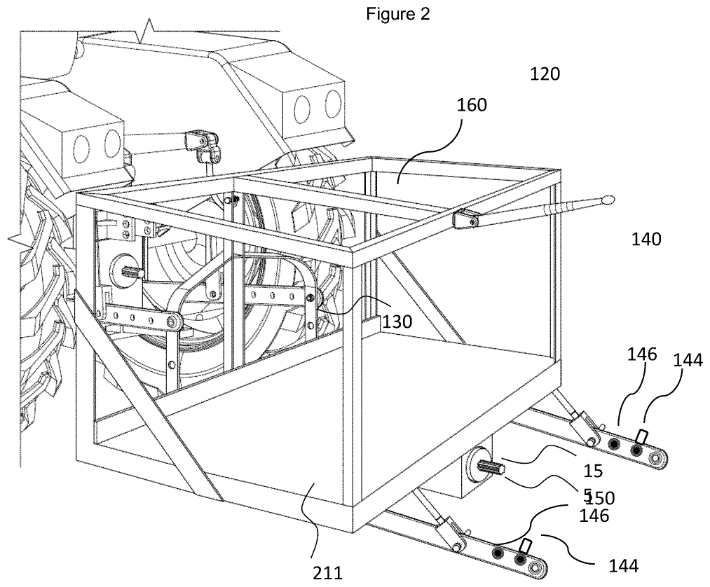

FIG. 2 is a side perspective view of an embodiment of the invention comprising a carry-all as the primary implement. FIG. 2 depicts a similar primary implement as that depicted in FIG. 1, but with a smaller platform 211 which may be more suitable to some uses. For convenience, the same numbering of other items is used in this Figure as in FIG. 1.

A typical example of a PTO drive shaft attachment is shown generally at 300 in FIG. 3. PTO drive attachment 300 comprises a universal joint 310 at each end which enables the shaft to remain connected and also able to continue to transfer rotational force from the tractor to the implement, even when the implement is moved up or down or sideways relative to the tractor. Furthermore, the shaft of attachment 300 comprises two telescopically slidable pieces 311 and 312 which enable the length of the shaft to change depending on the distance between the two PTO drive parts that are being connected. (This distance changes for example as the primary implement is raised and lowered and also with the dimensions of each secondary implement.)

Properties of PTO drive shaft attachments, such as universal joints and the ability to continue to transfer rotational force irrespective of changes in distance or angle between the two PTO drive points are important to the operation of those embodiments of the invention in which the user wishes to connect a secondary implement which requires PTO rotational force. In some embodiments it may be necessary to have one or more additional universal joints between the tractor and the apparatus of the invention in order to facilitate the full range of required movement of the primary implement or the secondary implement with respect to the tractor. In some embodiments, one or more additional specialised PTO drive shaft attachments may also be required between the primary and secondary implements.

Returning to FIGS. 1 and 2, the components of three point linkage 140 can be attached to the second side of the apparatus by any suitable means, but the attachment must be sufficiently strong so as to enable effective use of any secondary implements to be attached to the apparatus. Similarly, the construction of apparatus 120 and its primary implement should be such that the entire weight and all relevant forces created in use by any secondary implements can be readily and safely borne. In some embodiments, the entire frame of the apparatus and/or implement is made from reinforced or strengthened steel and a suitable set of attachment points are welded or attached with appropriately rated fixtures such as bolts to it. In some embodiments stabiliser bars such as bar 160 are used to reinforce or strengthen the attachment of one or more elements of the three point linkage 140.

The apparatus of this embodiment further comprises an apparatus PTO drive 155 which as described above can be connected to the PTO drive on the tractor via a PTO drive shaft attachment and therefore transmit rotational force (via male connector 150) originating from the tractor PTO drive to the secondary implement to be attached (via a second PTO drive shaft attachment) at the second side of the apparatus of this embodiment of the invention.

In this embodiment, the primary implement comprises a platform section 121 to which the three point linkage elements are attached. In this embodiment, there is no method of raising and lowering the secondary implement separately from the primary implement. Instead it is raised and lowered with the primary implement via their attachments at three point linkages 130 and 140 respectively. This underscores the need to have strong attachments and supporting framework on the apparatus (in this example, the primary implement is a carry-all).

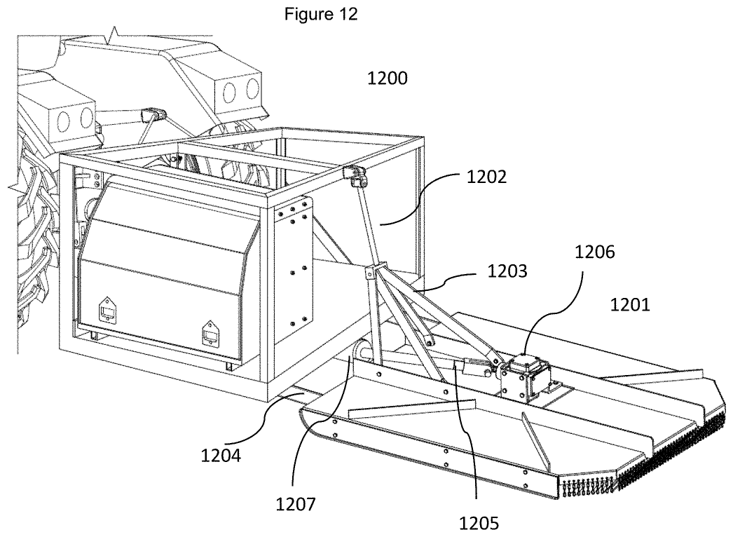

Apparatus of the invention that comprise primary implements with a platform such as a carry all as depicted in FIGS. 1 and 2 are particularly useful for enabling the user to perform multiple farm or land management tasks without the need to return to base (such as storage buildings or sheds) for further equipment. For example, fencing parts and tools may be stored on the platform of the primary implement of apparatus 120 and a slasher connected as the secondary implement (see FIG. 12). In this way, a land manager or farmer who is slashing a field can pause and repair a fence without having to separately retrieve the relevant fencing parts and tools which may be an inconvenient distance away. Similarly, a chainsaw may be stored on the primary implement, for example to trim or remove fallen branches or logs that may get in the way of slashing the paddock.

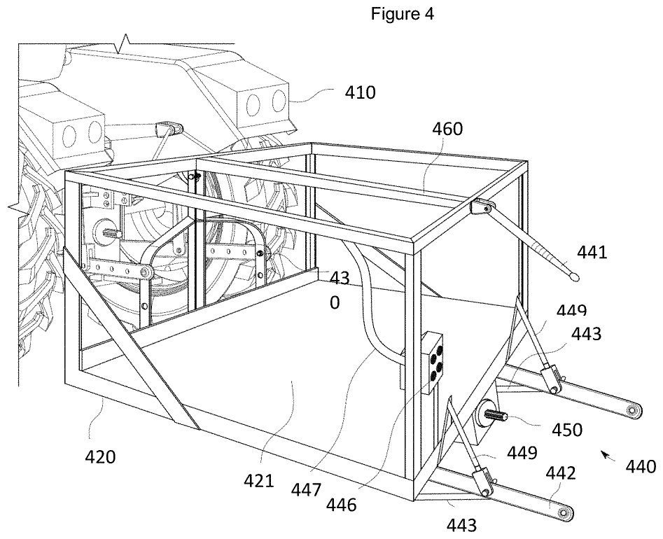

FIG. 4 is a side perspective view of an embodiment of the invention comprising a primary implement comprising a carry-all with additional hydraulic lift to raise or lower the secondary implement relative to the primary implement. FIG. 4 depicts the rear of a typical tractor 410, with apparatus 420 attached via tractor three point linkage 430. Apparatus 420 comprises a primary implement which comprises a platform 421, frame elements, brace 460 and three point linkage at the rear shown generally at 440. Three point linkage 440 on apparatus 420 comprises upper link 441 and lower links 442 and stabilising bars 443 to restrict lateral movement of lower links 442 in use. Upper link 441 and lower links 442 are adjustable in length in a similar way to that described for FIGS. 1 and 2. There are many other simple ways to enable adjustability of the length of the upper and lower links of the three point linkages of the invention.

In FIG. 4, apparatus 420 is not attached to PTO drive 135 of tractor 110. However, a PTO drive shaft attachment can be readily fitted between the tractor PTO drive and a complementary attachment on the apparatus PTO drive on apparatus 420 (not shown). This would have the effect of enabling rotational force from tractor PTO drive 135 to pass through to the apparatus PTO drive and therefore enable operation of any PTO drive elements of a secondary implement attached thereto via a second PTO drive shaft attachment to apparatus PTO drive output 450.

FIG. 4 illustrates a similar embodiment to that in FIG. 1, but for which lower links 442 of three point linkage 440 can be raised and lowered independently of the primary implement. In this embodiment, it uses lift rods 449 attached to hydraulic arms (not shown) from hydraulic cylinders or rams (not shown) which are connected by extension cables 447 to the standard hydraulic outlets on the rear of the tractor. It will be apparent that the hydraulic extension cables are also connected to a transfer box 446 (shown schematically) into which additional hydraulic cables can be plugged to enable hydraulic features or components on the secondary implement. In this embodiment, the secondary implement can be raised and lowered independently of the primary implement (in this example, a carry all).

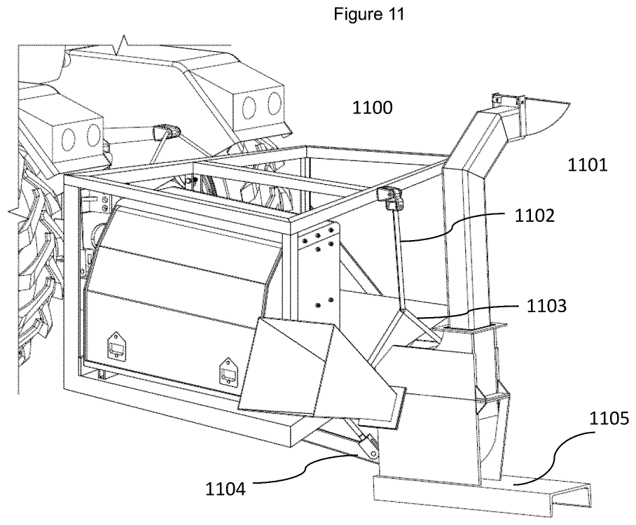

Some variants of this embodiment may comprise a stabiliser system to provide further stability to the apparatus structure for raising and lowering the secondary implement. For example, it may comprise one or more wheels, preferably which are able to swivel under the primary implement. In some preferred embodiments, such wheels can be folded up out of the way or removed when not required. In other embodiments, fold down or slide down stands or legs may be used on the primary implement to provide such stabilisation. Again, such stabilisers may also be able to be removed when not in use. An example of the use of such stabilisation may for example be when the secondary implement is one that is used in a stationary position, such as a wood chipper (see FIG. 11), wood splitter or back hoe. In such instances, the secondary implement will need to be positioned at an operating height (which in many instances may be on the ground but does not have to be), and it will help this process (and for example, reduce vibrations and potential damage to equipment) if the primary implement can also be stabilised during use.

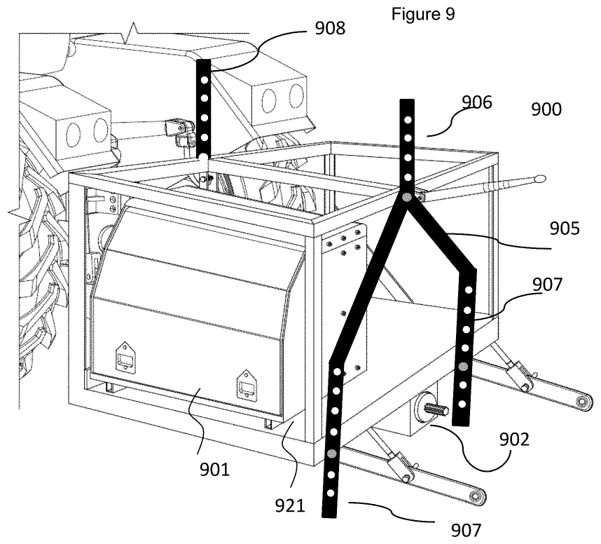

In other embodiments, better operational efficiency may be gained by having the primary and secondary implements at different heights. For example, when slashing a paddock (slasher as secondary implement) or mowing grass (mower as secondary implement), it would be preferable to have the primary implement at a higher level than the secondary implement and therefore out of the way so that it doesn't interfere with the pasture or grass as it enters the slasher or mower which must be positioned lower to the ground. This is taken into account in some embodiments that do not have the ability to separately raise and lower the secondary implement so that the secondary implement is fixed at a higher or lower position than the primary implement. See for example FIGS. 9, 11 and 12. For example, the secondary implement may be fixed in a lower position relative to the primary implement in a situation in which the secondary implement is a slasher, mower, hay rake, etc.

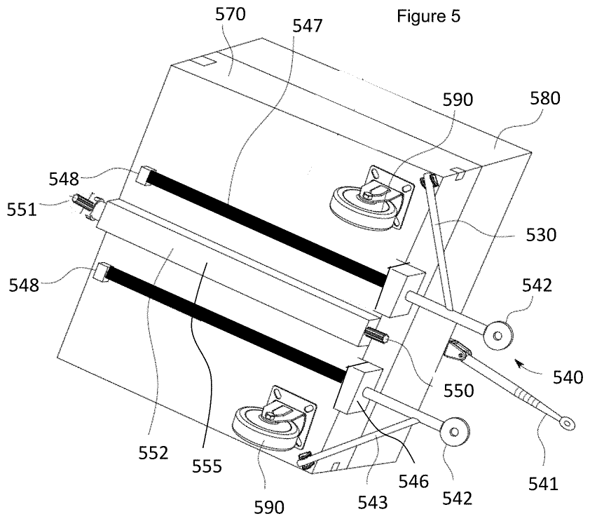

FIG. 5 is a perspective view from underneath of an embodiment of the invention comprising a carry-all as the primary implement with foldable support wheels. In this instance a box shaped carry all with sides 570 and fold down sides 580. In this figure the reinforcing structure is not shown, but three point linkage 540 is depicted semi-schematically with adjustable upper link 541 and adjustable lower links 542. Also depicted is the apparatus PTO drive extension 555 which has male attachment 551 for engagement with a PTO drive shaft attachment with universal joints (for example, as depicted in FIG. 3) which then connects to the tractor PTO drive (not shown). The main body of the apparatus PTO drive 555 is secured within housing 552 for safety reasons and to keep the drive shaft clean. Any suitable connections may be used at each end of the apparatus PTO drive extension 555. In the depicted embodiments, it is a male connector on each end for convenience since PTO drive shaft attachments in common use (such as the one depicted in FIG. 3) are typically female at each end.

In this embodiment lower links 542 are stabilised by stabilisers 530 and are also moveable up and down by virtue of hydraulic rams shown schematically as boxes 546, and again, hydraulic extension cables 547 are shown (in this embodiment placed under the implement) with connectors 548 for connecting to the hydraulic hoses on the tractor, potentially via extension cables. This variant of this embodiment also comprises wheels 590 which are on swivels (not shown) to provide further stability. These wheels may be able to be folded up or removed when not in use.

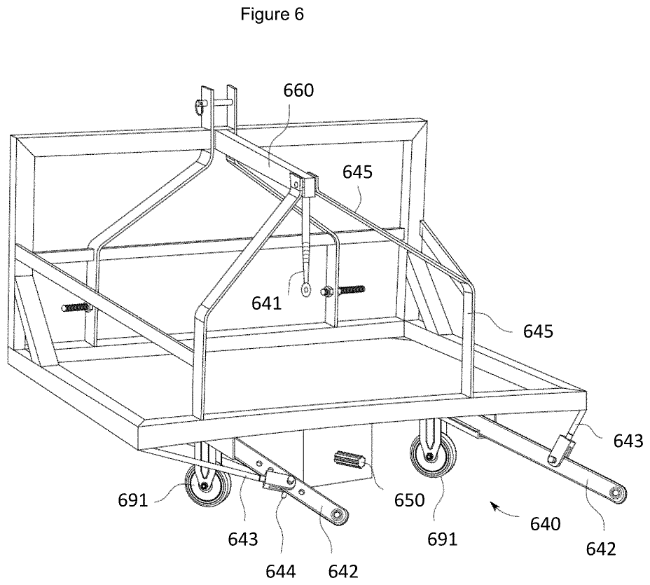

FIG. 6 is a side perspective view of an embodiment of the invention comprising a carry-all as the primary implement with foldable support wheels. In this embodiment, the primary implement comprises a platform, frame elements, brace 660 and three point linkage attachment at the second end shown generally at 640. Three point linkage 640 on this apparatus of the invention comprises upper link 641 and lower links 642 and stabilising bars 643 to restrict lateral movement of lower links 642 in use. Upper link 641 and lower links 642 are adjustable in length, for example, lower links 642 can be adjusted by sliding them and placing pin 644 in the appropriate hole to lock it in place. Frame 645 on the rear of the implement according to this embodiment provides support for the three-point linkage used to connect from the apparatus of the invention to the secondary implement (641, 642, 643, etc). Frame 645 may additional comprise adjustment means as depicted and described in relation to FIG. 9. Male connector 650 on apparatus PTO extension is shown as well. In this embodiment, the three point linkage is not able to be independently moved under power up and down relative to the primary implement, so that it is only raised when the primary implement is raised by the tractor three point linkage. This embodiment also comprises wheels 691 which are on swivels and able to fold up.

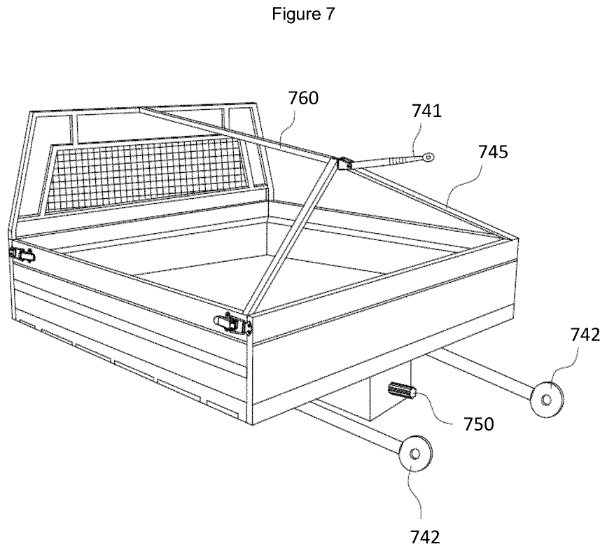

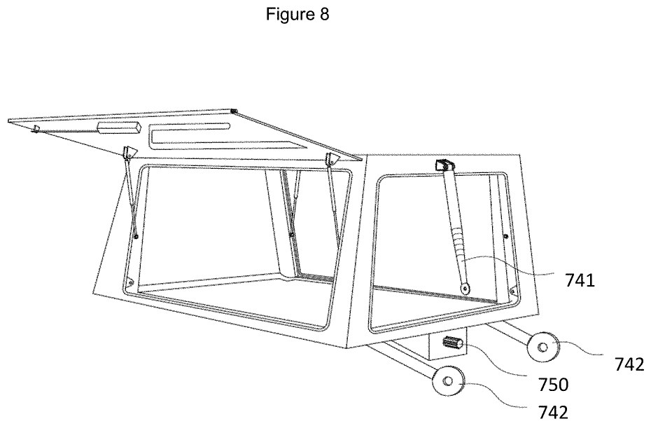

FIGS. 7 and 8 illustrate that in those embodiments comprising a carry all, a large number of variations are possible. FIG. 7 is a side perspective view of an embodiment of the invention comprising a carry-all in the shape of a pick-up truck or ute tray as the primary implement. FIG. 8 is a side perspective view of an embodiment of the invention comprising a covered carry-all as the primary implement. In some embodiments, a more traditional utility vehicle (or pickup truck) tray type shape may be used (as per FIG. 7). In the embodiment of this aspect which is depicted in FIG. 7, the secondary implement is not able to raise and lower independently of the first. However, other embodiments of this aspect may have this functionality. FIG. 8 illustrates a large ‘toolbox’ type primary implement in which a range of tools and other useful items may be kept out of the weather within the canopy and used as required on jobs around the farm or property. Both Figures depict upper link 741, lower links 742, and apparatus PTO drive extension 750. FIG. 7 also depicts brace 760 and frame element 745.

FIG. 9 is a side perspective view of an embodiment of the invention comprising a carry-all as the primary implement, the carry-all also has a tool box 901 fixed to its platform 921. It depicts an embodiment of the invention which is similar to those depicted in FIGS. 1 and 2. In FIG. 9, a PTO drive shaft attachment with two universal joints (as depicted in FIG. 3) connects the PTO drive on the tractor to the apparatus PTO drive extension (but is not shown) which transfers the rotational force of the tractor PTO drive to the PTO drive on the second side of the apparatus 902. This embodiment comprises a toolbox 901 fixed to platform 21 and provides still further utility for the user as tools can be stored and locked away in an organised manner whilst other materials (such as fence posts/wires/logs/etc) can be carried on the platform—all whilst retaining the ability to use a secondary implement.

In some embodiments, the three point hitch points on the first side and the three point hitch linkage on the second side of the primary implement are independently adjustable so as to raise or lower the three-point hitch independently from its normal operation. Such adjustability may be achieved by any suitable means, for example by a series of holes in a frame to which the three point hitch or linkage components can be releasably fixed so that the frame (and thereby the three point hitch) can be set at different levels and then fixed in place, for example with a pin, or bolted in place. FIG. 9 illustrates one example embodiment in which the three point linkage on the second end of the apparatus can be set at a range of heights. In this embodiment this is done by virtue of adjustment frame 905 which is fixed for example by welding or mechanical fixture to the frame of the apparatus, and has lower link height adjustment arms 907 and upper link height adjustment arm 906. Each of the arms 906 and 907 comprise a series of holes to which the upper and lower link points on the upper and lower links can be attached, for example with a simple pin or bolt. In this example, the lower links are attached to the third from the bottom holes on arm 906 and the upper link is attached to the lowest available hole on upper arm 906. Upper hitch point attachment arm 908 is also visible on the first end of the apparatus, but the remainder of the hitch point adjustment means is not shown. Hitch point adjustment means can work in the same way as for the upper and lower link height adjustment arms 906 and 907 on the second end of the apparatus and therefore adjust the height of the hitch points of the apparatus relative to its primary implement.

In some embodiments the primary implement is an earth moving implement, such as a grader blade, a bed former, a box blade scraper, dirt scoop, harrows, a ripper, a plough or a tillage implement. In these embodiments it may be useful to have a second earth moving implement as the secondary implement. For example a ripper as primary implement to turn up the soil followed by a grader to move it sideways or a smudge bar to flatten it. In some embodiments it may be useful to have a different type of secondary implement, such as a set of harrows to rake out freshly ploughed earth, or spread manure across it.

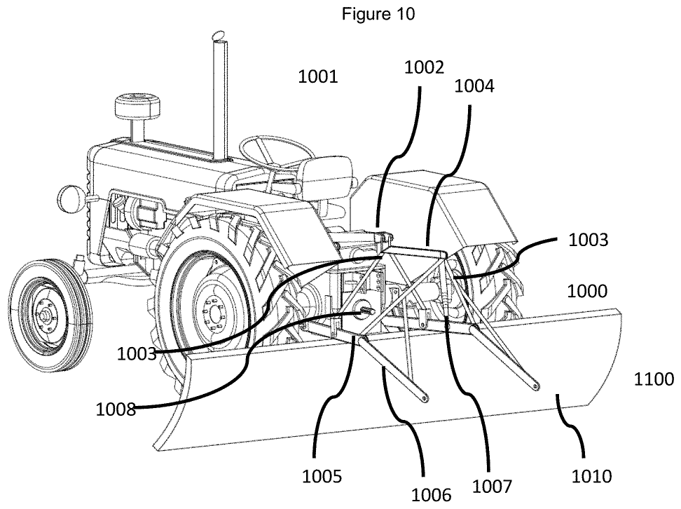

FIG. 10 is a side perspective view of an embodiment of the invention shown generally at 1000 comprising a grader blade attachment 1010 as the primary implement. Primary implement 1000 on the apparatus of the invention is attached to the upper link 1002 of tractor 1001 via support frame 1003 and brace 1004 and tractor lower links 1005. In this figure, there is no secondary implement attached, so that lower links 1006 and upper link 1007 of primary implement 1000 are unattached. In this embodiment, there is no PTO extension to extend the PTO drive mechanism from tractor PTO drive 1008 through to a secondary implement. However, in some embodiments which comprise a grader blade as the primary implement, a PTO drive extension may be used in this way so that rotational force from the tractor's PTO drive can be transferred to a secondary implement as required. The primary implement of the invention may comprise a wide range of earth treating agricultural implements, such as for example, a grader blade, bed former, a box blade scraper, dirt scoop, harrows, a ripper, a rotary hoe, a plough, an s-tine cultivator, a tillage implement, and so on. In some embodiments a primary implement comprising an earth treating agricultural implement may be used in conjunction with a secondary implement such as a spreader or seeder, such that the earth is first ploughed or tilled, for example and then spread with seed or a fertiliser etc.

FIG. 11 is a side perspective view of an embodiment of the invention comprising a carry-all with toolbox (as depicted in FIG. 9) shown generally at 1100 as the primary implement and attached via a three point linkage to a wood chipper as the secondary implement shown generally at 1101. Apparatus three-point linkage upper link 1102 attaches to a triangular support frame 1103 on chipper 1101. In addition, apparatus lower links 1104 attach to the base of chipper 1101. Wood chipper 1101 is designed to be placed on the ground for operation to provide support against vibrations during operation as shown by support base 1105. The tractor PTO drive is attached via a PTO drive shaft attachment (not shown, but see FIG. 3) to the PTO extension of apparatus 1100 which transfers the rotational force from the tractor via a second PTO drive shaft attachment to chipper 1101 (not shown). It is evident from this Figure that the primary implement of apparatus 1100 is designed to be set up off the ground when chipper 1101 is placed on the ground for use. The relative heights of the two implements can be set at a range of values based on adjustment of the three-point linkages of the tractor and the primary implement. See FIG. 9.

FIG. 12 is a side perspective view of an embodiment of the invention comprising a carry-all with toolbox shown generally at 1200 as the primary implement and attached via apparatus three point linkage to a slasher as the secondary implement shown generally at 1201. In this embodiment, apparatus three-point linkage upper link 1202 attaches to supports 1203 on slasher 1201. Lower links 1204 from the apparatus three-point linkage attach to hitch points on the base of slasher 1201. PTO drive shaft attachment 1205 connects the gear box and drive mechanism 1206 of slasher 1201 to the PTO drive extension 1207 of apparatus 1200 to transfer the rotational force from the tractor's PTO drive and thereby drive the slasher blades (not shown). In this embodiment, the secondary implement (slasher 1201) is not separately moveable up and down relative to the primary implement as there is no separate hydraulic mechanism to do this. Instead, they are fixed at relative heights which can be determined by adjustments as described in relation to FIG. 9, and to a lesser extend adjustments to the apparatus three point linkage. It is evident from the figure that the slasher 1201 is set at a lower height than primary implement so that the primary implement does not flatten the pasture too much before it enters slasher 1201 to be cut.

In some embodiments of the invention, the three point hitch points on the apparatus of the invention used to connect to the tractor three point linkage are fixed at a lower level so that the implement, when hitched, sits at a greater height above the ground than would normally be the case for another implement. This makes it easier for an operator to ensure adequate height distance between the primary implement and the secondary implement as for example required in the two implementations depicted in FIGS. 11 and 12. A still greater relative distance can also be achieved by fixing the apparatus three point linkage on the second side of the primary implement at a lower level than would normally be the case. See FIG. 9 for an example adjustment frame for setting the three point hitch points at higher or lower levels and setting the three point linkage of the apparatus at higher or lower levels.

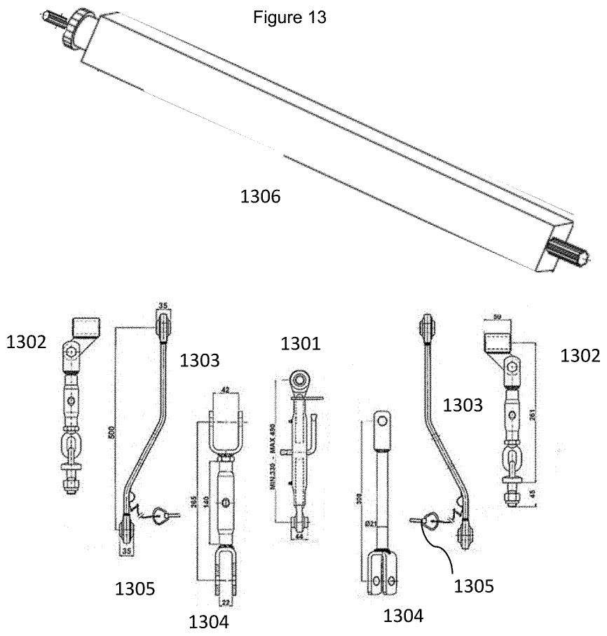

FIG. 13 depicts an example kit of parts for retrofitting, for example to a carry-all to manufacture an apparatus with primary implement according to the invention. This example kit according to the invention comprises upper link 1301, lower links 1303, side stabiliser bars 1302, lift rods 1304 with adjustment pin 1305. In some implementations of the kit according to the invention, the lift rods are not required—for example where the primary implement to be converted is not able to separately hydraulically lift the secondary implement relative to itself. Some embodiments of a kit according to the invention also comprise reinforcing bars or frames to be welded or attached (for example with clamps or bolts) to pre-existing components (for example, of a carry-all implement) so as to strengthen it against the additional forces likely to be applied when carrying and operating a secondary implement. In some embodiments of the kit according to the invention, a complete frame is provided, complete with attachment points for the components of the three point linkage itself. Such a frame may be attachable (for example by welding or bolts etc) to the pre-existing implement so as to provide the strengthened infrastructure in a simple step.

One example implementation of the kit according to the invention is in relation to retrofitting such a kit to a pre-existing carry-all. According to this example, a PTO drive extension is attached to the underside of the carry-all. The PTO drive extension is preferably attached with steel supports that hold the PTO extension in place and which are attached to the frame of the carry-all. Such steel supports may be of any suitable type provided that they can hold the PTO extension so that it can rotate but not otherwise move relative to the frame of the carry-all. In addition, the PTO extension must be covered with a safety cover or shroud to ensure that the rotating PTO extension drive does not inadvertently catch on something, including human body parts. In some preferred embodiments, the safety cover comprises the steel supports which are accessible and able to be fixed (such as bolted or welded) to the frame of the carry-all. In these embodiments the retrofitting process is made easier as it is simply a matter of attaching a single piece of equipment to the underside frame of the carry-all. A typical carry-all will already have three-point hitching points for the three-point linkage of the tractor to connect to. However, in order to make it operable as an apparatus with primary implement according to the invention, an additional three-point linkage must be added to the second side of the carry-all so that it can hitch to three point hitch points on a secondary implement. In some preferred embodiments, the apparatus three point linkage can be pre-assembled for ready fixing (such as by bolts or welds) to the frame of the carry-all. In some embodiments, there are also provided further supports to be fixed (bolted or welded) on to the carry-all frame to enable more sturdy attachment of the apparatus three point linkage. In some embodiments, further hydraulic equipment must also be added in order to enable the secondary implement to be raised and lowered independently of the primary implement.

The carry all embodiments of the invention increase the usefulness of a tractor in many ways. Tractors usually have little room to carry tools or other items on or about them or in the cab, if there is one. By using a carry all embodiment of the current invention, a land manager can turn his or her utility tractor into a utility vehicle (ute) as well. It will enable the land manager to carry various items or tools in the carry all, whilst maintaining the ability to transport and use a secondary implement. So for example, the land manager could use the invention to carry fencing tools and wood cutting tools to a part of the farm where fencing repair and fire wood collection is required and tow a trailer to collect the firewood or a splitter to split it and then load it in the carry all. This could be done with the embodiment of example 7, or any of the other embodiments, by attaching a tow ball attachment to the three point linkage on the second end of the apparatus.

The interposition of an apparatus of the invention with primary implement between the tractor and the secondary implement can give rise to problems for the operator in seeing and therefore fully using the secondary implement. For example, if using the implement whilst reversing the tractor or even to maintain a visual check that operations are working. In some embodiments the apparatus or its primary implement is fitted with a camera so that the operator can obtain a better view of what is occurring. The video screen can be placed in any suitable position, but in some preferred embodiments it is placed in the rear of the tractor so that the operator can glance between it and the actual rear view visible from his or her seat on the tractor.

The following section sets out more detail in relation to preferred dimensions and requirements for linkages and hitches on apparatus according to the invention. It should be noted that the dimensions provided below may need to vary in case of specialised implements. It should also be noted that some of the dimensions and requirements apply only to those embodiments comprising a mechanism to raise and lower a secondary implement relative to the primary implement. It will be appreciated that the three point linkage used on the apparatus of the invention to attach to a secondary attachment can be of any of the known types, as set out in the below table.

| | PTO power at rated rotational |
|---|---|
| Category | frequency of engine (kW) |
| 1N | Up to 35 |
| 1 | Up to 48 |
| 2N/2 | 30 to 92 |
| 3N/3 | 60 to 185 |
| 4N/4 | 110 to 350 |

Certain specialised implements or farming operations that require narrow spacing require special consideration for the three-point linkage (1N, 2N, 3N and 4N).

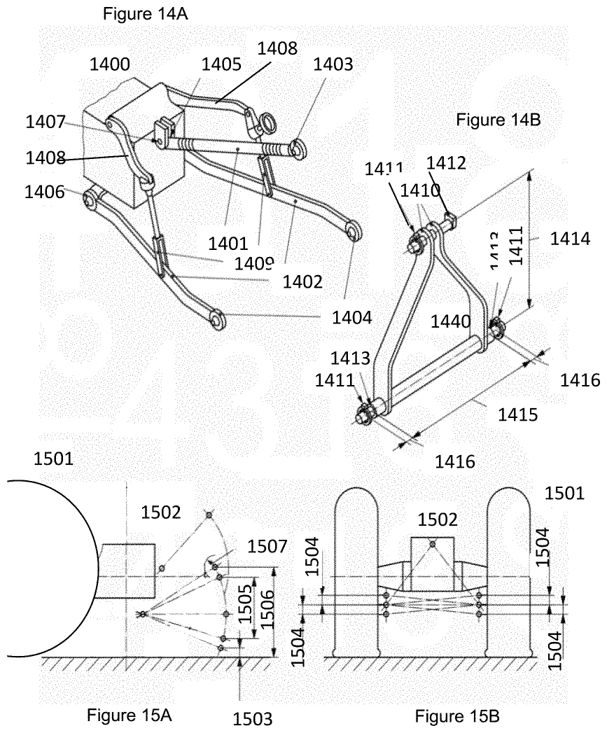

FIGS. 14A and 14B are side perspective views of a typical three-point linkage from an apparatus of the invention (1400) and the hitch points on a secondary implement (1440). Apparatus 1400 comprises upper link 1401, which is the upper linkage element, fitted with an articulated connection at both ends and lower links 1402, which are the lower linkage elements, fitted with an articulated connection at both ends. Upper link 1401 has an upper hitch point 1403 which is an articulated connection between the upper link and the implement and an upper link point 1405 which is an articulated connection between the upper link and the apparatus of the invention 1400. Upper link 1401 is connected to apparatus 1400 by upper link attachment 1407 which in this embodiment is a pin by which the upper link is connected to the apparatus of the invention 1400. Lower links 1402 have lower hitch points 1404 which are articulated connections between a lower link and the secondary implement and lower link points 1406 which are articulated connections between the lower link and the apparatus of the invention 1400. Apparatus 1400 is of the type that comprises hydraulic capacity and so therefore comprises hydraulic lift arms 1408 which are connected via lift rods 1409 to lower links 1402 to transmit force from the hydraulic lift arms 1408 so that lower links 1402 (and therefore the secondary implement via its three point hitch points) can be raised or lowered.

The hitch points on secondary implement 1440 comprise a mast 1410 which provides the location of the upper hitch point on the implement. The height of mast 1410 (signified by distance 1414) is the vertical distance between the upper hitch point and the common axis of the lower hitch points. The upper link 1401 of apparatus 1400 attaches to the mast 1410 of secondary implement three point hitch by passing upper hitch attachment 1412 (pin, usually detachable and forming part of the upper link assembly, by which an upper link is secured) through a first hole in mast 1410, then through the hole defined by upper hitch point 1403 then through the second hole in mast 1410 as shown and securing it with linchpin 1411 (pin, usually fitted with a spring-retaining device, by which an articulated connection is retained in position).

Lower links 1402 on the three point linkage of apparatus 1400 are attached to the hitch points 1440 of the secondary implement by passing the holes defined by lower hitch points 1404 over lower hitch attachment 1413 (pin, or clevis and pin, usually attached to the implement, by which a lower link is secured) on hitch points 1440 and securing it with linchpin 1411 (pin, usually fitted with a spring-retaining device, by which an articulated connection is retained in position). The distance between the shoulders of the lower hitch pins, against which the sides of the lower link ball joints abut is referred to herein as lower hitch point span 1415. The distance from the centreline of the linchpin hole to the shoulder of the hitch pin is referred to herein as the linchpin hole distance 1416.

FIGS. 15A and 15B are schematics depicting dimensions for three point linkages on apparatus of the invention. FIG. 15A is a side schematic view showing rear tractor wheel 1501 and apparatus of the invention 1502 attached to the rear of the tractor via a three point linkage (not shown). Similarly, FIG. 15B depicts a rear schematic view of the same set up as in FIG. 15A. It will be appreciated that in FIG. 15B, apparatus 1502 is set forward from tractor wheels 1501 (and attached via a three point linkage which is not shown) but that because of the view, this separation between them is not evident.

Lower hitch point height 1503 is the height of the centre of the lower hitch points above the ground level when they are fully lowered using the full extent of manual adjustment for example, provided in the lift rods (in embodiments which comprise them), in conjunction with the movement range, and when the lower hitch point axis is maintained horizontal to the ground in a transverse plane. For reasons of interoperability, usability and safety, the lower hitch point height 1503 is preferably up to a maximum of 200 mm for category 1N and 1 hitches, and up to a maximum of 203 mm for category 2N, 2, 3N, 3, 4N and 4 hitches.

The levelling adjustment 1504 is the movement allowing inclination of the secondary implement, measured vertically and with one lower link horizontal, so that either lower hitch point can be moved higher or lower than the other. For reasons of interoperability, usability and safety, the levelling adjustment 1504 is preferably at least 75 mm for a category 1N hitch, a minimum of 100 mm for category 1, 2N and 2 hitches, at least 125 mm for category 3N and 3 hitches and at least 150 mm for category 4N and 4 hitches.

For embodiments which comprise the ability to raise or lower the secondary implement relative to the first, the movement range 1505 is the vertical movement of the lower hitch points corresponding to the power travel of the lift, excluding any adjustment in the lift rod linkage. For reasons of interoperability, usability and safety, the movement range 1505 is preferably at least 610 mm for category 1N and 1 hitches, at least 650 mm for category 2N and 2 hitches, at least 735 mm for category 3N and 3 hitches, and at least 760 mm for category 4N and 4 hitches. Note that movement range for PTO power above 65 kW should be at least 700 mm.

The transport height 1506 is the total height of the lower hitch points above the ground using the full extent of manual adjustment provided (for example in the lift rods if provided) in conjunction with the movement range, with the lower hitch point axis maintained horizontal to the ground in a transverse plane. For reasons of interoperability, usability and safety, the transport height 1506 (lower hitch point axis to be horizontal throughout) should be at least 600 mm for a category 1N hitch, at least 820 mm for a category 1 hitch, at least 950 mm for category 2N and 2 hitches, at least 1065 mm for category 3N and 3 hitches and at least 1200 mm for category 4N and 4 hitches.

For use with tractors of particularly large size or particularly large sized tyres, the lower hitch point clearance 1507 is the clearance, expressed as a radial dimension, from the lower hitch point axis to the outside diameter of the tyre, mudguard or other part of the tractor, measured in a longitudinal vertical plane with the implement raised to transport height and all side-sway prevented. For reasons of interoperability, usability and safety, the lower hitch point clearance 1507 should be at least 90 mm for a category 1 hitch, 100 mm for category 1, 2N, 2, 3N, 3, 4N, and 4 hitches.

It should be appreciated that the term ‘pitch’ refers to the angle of the mast to the vertical, considered positive when viewed anticlockwise from the left-hand side of the tractor. The mast adjustment is the usable range of pitch of the mast from a vertical plane, measured at the maximum and minimum heights of the lower hitch points above the ground between which the mast, at the specified mast height, can be adjusted to any inclination between +5° and −5° from the vertical for categories 1, 2N, 2, 3N, 3, 4N and 4, and between the vertical and 10° to the vertical towards the rear for category 1N. For reasons of interoperability, usability and safety, the mast adjustment height should for a category 1N hitch have a lowest position of no more than 200 mm and a highest position of at least 420 mm, and for a category 1 hitch, have a lowest position of no more than 200 mm and a highest position of at least 508 mm, and for category 2N and 2 hitches, have a lowest position of no more than 200 mm and a highest position of at least 610 mm, and for category 3N and 3 hitches, have a lowest position of no more than 230 mm and a highest position of at least 660 mm, and for category 4N and 4 hitches, have a lowest position of no more than 255 mm and a highest position of at least 710 mm.

The torsional free float distance is the vertical distance over which either of the lower hitch points can move freely relative to the other to allow the implement to roll, with lower links initially horizontal. It is important that the torsional free float may be able to be blocked and for reasons of interoperability, usability and safety, should be a minimum of 60 mm for hitch categories 1N, 1, 2N and 2, a minimum of 75 mm for hitch categories 3N, 3, 4N and 4.

The transport pitch is the pitch reached by the mast when lifted to standard transport height from a position with lower links horizontal and mast vertical. It is important that the upper link point arrangements are such that transport pitches of −3° to +3° and +10° to +15° can be achieved at the standard mast height.

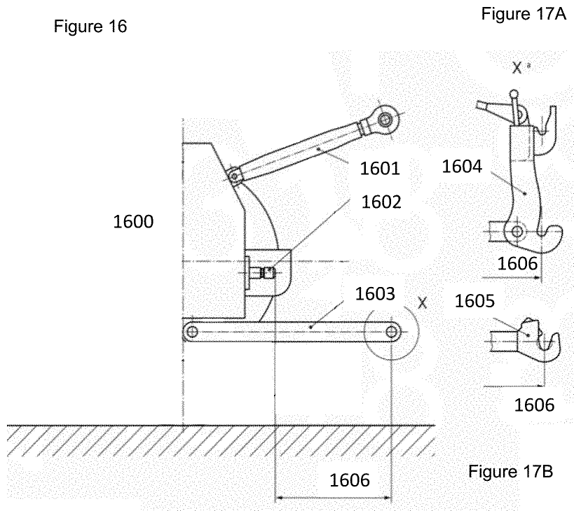

FIG. 16 is a side view of a three point linkage on an apparatus of the invention. FIGS. 17A and 17B comprise side views of two alternative lower hitch points for an apparatus of the invention. Apparatus 1600 has upper link 1601, lower link 1603 and PTO drive 1602. FIGS. 17A and 17B illustrate two alternative couplers that can be used to facilitate ready attachment to a secondary implement, being a U frame coupler 1604 and a link coupler 1605. Distance 1606 is the distance from the end of the power take-off to the centre of the lower hitch point, with the lower link horizontal. For reasons of interoperability, usability and safety, for a 35 mm PTO shaft, for a category 1N hitch, this distance is preferably in the range 300 to 375 mm and more preferably 350 mm, and for a category 1 hitch preferably in the range 500 to 575 mm and more preferably 550 mm, and for categories 2N and 2 hitches, the distance is preferably in the range 510 to 675 mm and more preferably 600 mm and for category 3N or 3 hitches, preferably in the range 560 to 725 mm or more preferably 650 mm. A 35 mm PTO shaft is not recommended for category 4N or 4 hitches. For reasons of interoperability, usability and safety, for a 45 mm PTO shaft, for category 2N or 2 hitches, this distance is preferably in the range 590 to 725 mm and more preferably 600 mm, and for category 3N or 3 hitches preferably in the range 640 to 775 mm and more preferably 650 mm, and for category 4N or 4 hitches, preferably in the range 650 to 875 mm and more preferably 750 mm.

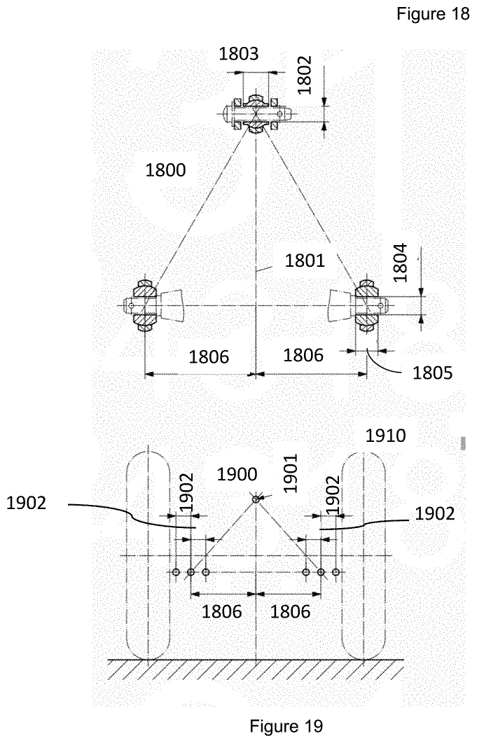

FIG. 18 is a rear view schematic depicting preferred dimensions for certain embodiments for three point hitches mounted on an apparatus of the invention. FIG. 19 is a rear view schematic depicting preferred dimensions for certain embodiments for three point linkages mounted on an apparatus of the invention. It will be appreciated that in FIG. 19, the apparatus of the invention is set forward from tractor wheels 1910 (and attached via a three point linkage which is not shown) but that because of the view, this separation between them is not evident. An apparatus according to the invention is shown generally at 1800 in FIGS. 18 and 1900 in FIG. 19 and the hitch point triangle is shown as 1901 in FIG. 19. Apparatus 1800 has axis 1801.

For reasons of interoperability, usability and safety, the diameter of the hitch pin hole on the upper hitch points 1802 for the hitch on an apparatus according to the invention for categories 1N or 1 hitches is preferably in the range 19.1 to 19.5 mm and more preferably 19.3 mm; and for category 2N or 2 hitches is preferably in the range 25.7 to 25.9 mm and more preferably 25.7 mm, and for category 3N or 3 hitches is preferably in the range 32 to 32.25 mm and preferably 32 mm, and for category 4N and 4 hitches is preferably in the range 45.2 to 45.5 mm and more preferably 45.2 mm.

For reasons of interoperability, usability and safety, the width of the ball on the upper hitch points 1803 for the hitch on an apparatus according to the invention for categories 1N or 1 hitches is preferably in the range 43.5 to 44 mm and more preferably 44 mm; and for category 2N or 2 hitches is preferably in the range 50.5 to 51 mm and more preferably 51 mm, and for category 3N or 3 hitches is preferably in the range 50.75 to 51 mm and preferably 51 mm, and for category 4N and 4 hitches is preferably in the range 63.5 to 64 mm and more preferably 64 mm.

For reasons of interoperability, usability and safety, the diameter of the hitch pin hole for the lower hitch points 1804 for the hitch on an apparatus according to the invention for categories 1N or 1 hitches is preferably in the range 22.4 to 22.65 mm and more preferably 22.4 mm; and for category 2N or 2 hitches is preferably in the range 28.7 to 29 mm and more preferably 28.7 mm, and for category 3N or 3 hitches is preferably in the range 37.4 to 37.75 mm and preferably 37.4 mm, and for category 4N and 4 hitches is preferably in the range 51 to 51.5 mm and more preferably 51 mm.

For reasons of interoperability, usability and safety, the width of the ball for the lower hitch points 1805 for the hitch on an apparatus according to the invention for categories 1N or 1 hitches is preferably in the range 34.5 to 35 mm and more preferably 35 mm; and for category 2N or 2 hitches is preferably in the range 44.5 to 45 mm and more preferably 45 mm, and for category 3N or 3 hitches is preferably in the range 44.5 to 45 mm and preferably 45 mm, and for category 4N and 4 hitches is preferably in the range 57 to 57.5 mm and more preferably 57.5 mm.

For reasons of interoperability, usability and safety, the lateral distance from the lower hitch point to the centreline of the implement according to the invention 1806 for a category 1N hitch it is preferably in the range 207 to 229 mm and more preferably 218 mm; and for a category 1 hitch it is preferably in the range 341 to 377 mm and more preferably 359 mm, and for category 2 or 3N hitches it is preferably in the range 413 to 457 mm and preferably 435 mm, and for category 3 and 4N hitches it is preferably in the range 479 to 530 mm and more preferably 505 mm and for a category 4 hitch, it is preferably in the range 581 to 642 mm and preferably 612 mm. Note that if a U frame coupler is used in conjunction with a 4N hitch then preferably this dimension should be in the range 464 mm to 514 mm and more preferably about 489 mm.

For reasons of interoperability, usability and safety, the lateral movement of the lower hitch point 1902 for the hitch on an apparatus according to the invention for a category 1N hitch it is preferably in the range 50 to 55 mm and preferably at least 50 mm, and for category 1 or 2N hitches it is preferably in the range 100 to 110 mm and more preferably about 100 mm; and for category 2, 3N, 3, 4N and 4 hitches it is preferably in the range 125 to 138 mm and more preferably at least 125 mm. Note that in some applications (for example for a wagon hitch or with wide tyre sizes on the tractor), it may be necessary to reduce these dimensions by up to 35 mm. Note that in some specialised applications in which the tractor has a track width of less than or equal to 1150 mm, then this dimension may be reduced for category 1 and 2N hitches to a range of preferably 50 to 55 mm and more preferably at least 50 mm.

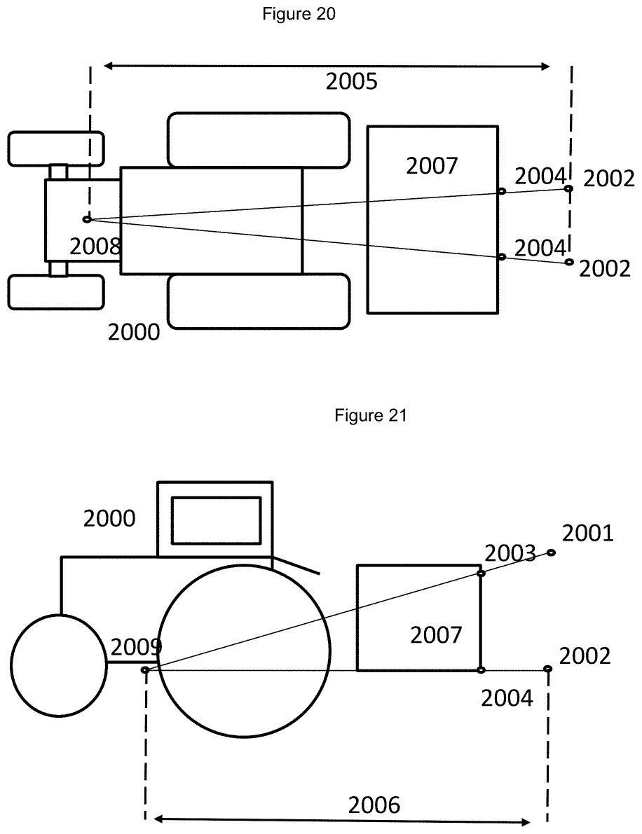

FIG. 20 is a plan view schematic depicting preferred dimensions for certain embodiments for three point linkages mounted on an apparatus of the invention. FIG. 21 is a side view schematic depicting preferred dimensions for certain embodiments for three point linkages mounted on an apparatus of the invention. Tractor 2000 is attached to an apparatus according to the invention 2007 attached via a tractor three-point hitch (not shown). The apparatus comprises upper hitch point 2001, lower hitch point 2002, upper link point 2003 and lower link point 2004. Horizontal convergence distance 2005 is the horizontal distance from the lower hitch points to the point of convergence of the lower links with the lower links are horizontal and laterally symmetrical, seen in a plan view. Vertical convergence distance 2006 is the horizontal distance from the lower hitch points to the point of convergence formed in the vertical longitudinal plane by the upper link and the lower links. Vertical virtual hitch point 2009 and Horizontal virtual hitch point 2008 are also depicted.

The horizontal convergence distance 2005 is important for the horizontal stability of implements. If the horizontal convergence distance is too large, the lateral stability of directional implements is decreased. If the horizontal convergence distance is too short, non-directional implements, such as harrows, easily find equilibrium positions asymmetric to the tractor. For many implements, especially long multi-row ones, this leads to decreased quality of work. Preferably, the horizontal convergence distance should be 1700 mm to 2400 mm for category 1 and 1N hitches, 1800 mm to 2400 mm for category 2, 2N and 3N hitches, 1900 to 2700 mm for category 3 hitches, 1900 to 2700 mm for category 4N hitches and 1900 to 2800 mm for category 4 hitches.

The vertical convergence distances is important for stable working conditions and make it possible to reduce the influence of tractor movements (pitching, rolling, turning) on connected implements and to provide for wide interchangeability of tractors and implements designed by different producers. To achieve these properties for a linkage, the vertical convergence should be not less than 0.9 times the tractor wheelbase and preferable at least the same length as the tractor wheelbase.

One aspect of the invention provides an apparatus for attachment to a utility tractor, the apparatus having a first end and a second end and comprising: a frame; a primary implement; at the first end, an upper hitch point and two lower hitch points for connecting to the three point linkage of a tractor; at the second end, a three point linkage for attachment to three point hitch points of a secondary implement, the three point linkage welded or mechanically fastened to the frame so as to support the weight of and use of a secondary implement, and the three point linkage comprising a length-adjustable upper link and two length-adjustable lower links.

In another aspect of the invention, there is provided an apparatus for attachment to a utility tractor, the apparatus having a first end and a second end and comprising: a frame; a primary implement; at the first end, an upper hitch point and two lower hitch points for connecting to the three point linkage of a tractor; at the second end, a three point linkage for attachment to three point hitch points of a secondary implement, the three point linkage welded or mechanically fastened to the frame so as to support the weight of and use of a secondary implement, and the three point linkage comprising a length-adjustable upper link and two length-adjustable lower links; a power take-off extension extending from the first end to the second end to enable transfer of rotational force from the power take-off of the tractor through to the secondary implement, the power take off extension comprising a housing, and an attachment at each end for connection to, at the first end, the tractor power take-off via a first PTO drive shaft attachment and at the second end the secondary implement power take off receiver via a second PTO drive shaft attachment.

In one aspect of the invention, there is provided an apparatus for attachment to a utility tractor, the apparatus having a first end and a second end and comprising: a frame; a primary implement; at the first end, an upper hitch point and two lower hitch points for connecting to the three point linkage of a tractor; at the second end, a three point linkage for attachment to three point hitch points of a secondary implement, the three point linkage welded or mechanically fastened to the frame so as to support the weight of and use of a secondary implement, and the three point linkage comprising a length-adjustable upper link and two length-adjustable lower links, each lower link connected to a stabilising bar to restrict lateral movement in use; a power take-off extension extending from the first end to the second end to enable transfer of rotational force from the power take off of the tractor through to the secondary implement, the power take off extension comprising a housing, and an attachment at each end for connection to, at the first end the tractor power take-off via a first PTO drive shaft attachment and at the second end the secondary implement power take off receiver via a second PTO drive shaft attachment.

In yet another aspect, the invention provides an apparatus for attachment to a utility tractor, the apparatus having a first end and a second end and comprising: a frame; a primary implement; at the first end, an upper hitch point and two lower hitch points for connecting to the three point linkage of a tractor; at the second end, a three point linkage for attachment to three point hitch points of a secondary implement, the three point linkage welded or mechanically fastened to the frame so as to support the weight of and use of a secondary implement, and the three point linkage comprising a length-adjustable upper link and two length-adjustable lower links, each lower link connected to a stabilising bar to restrict lateral movement in use; a power take-off extension extending from the first end to the second end to enable transfer of rotational force from the power take off of the tractor through to the secondary implement, the power take off extension comprising a housing, and a male attachment at each end for connection to power take off shafts at each end for connection to at the first end, the tractor power take-off via a first PTO drive shaft attachment and at the second end the secondary implement power take off receiver via a second PTO drive shaft attachment.

In one aspect, the invention provides an apparatus for attachment to a utility tractor, the apparatus having a first end and a second end and comprising a frame; a primary implement; at the first end, an upper hitch point and two lower hitch points for connecting to the three point linkage of a tractor; at the second end, a three point linkage for attachment to three point hitch points of a secondary implement, the three point linkage welded or mechanically fastened to the frame so as to support the weight of and use of a secondary implement, and the three point linkage comprising a length-adjustable upper link and two length-adjustable lower links, each lower link connected to a stabilising bar to restrict lateral movement in use; a power take-off extension extending from the first end to the second end to enable transfer of rotational force from the power take off of the tractor through to the secondary implement, the power take off extension comprising a housing, and a male attachment at each end for connection to power take off shafts at each end for connection to at the first end, the tractor power take-off via a first PTO drive shaft attachment and at the second end the secondary implement power take off receiver via a second PTO drive shaft attachment; three point linkage adjustment means to raise or lower the point of attachment of the three point linkage at the second end of the apparatus relative to the primary implement.

In another aspect, the invention provides an apparatus for attachment to a utility tractor, the apparatus having a first end and a second end and comprising: a frame; a primary implement; at the first end, an upper hitch point and two lower hitch points for connecting to the three point linkage of a tractor; a the second end, a three point linkage for attachment to three point hitch points of a secondary implement, the three point linkage welded or mechanically fastened to the frame so as to support the weight of and use of a secondary implement, and the three point linkage comprising a length-adjustable upper link and two length-adjustable lower links, each lower link connected to a stabilising bar to restrict lateral movement in use; a power take-off extension extending from the first end to the second end to enable transfer of rotational force from the power take off of the tractor through to the secondary implement, the power take off extension comprising a housing, and a male attachment at each end for connection to power take off shafts at each end for connection to at the first end, the tractor power take-off via a first PTO drive shaft attachment and at the second end the secondary implement power take off receiver via a second PTO drive shaft attachment; three point hitch point adjustment means to raise or lower the point of attachment of the three point hitch at the first end relative to the primary implement; three point linkage adjustment means to raise or lower the point of attachment of the three point linkage at the second end of the apparatus relative to the primary implement.

In another aspect of the invention, there is provided an apparatus for attachment to a utility tractor, the apparatus having a first end and a second end and comprising: a frame; a primary implement; at the first end, an upper hitch point and two lower hitch points for connecting to the three point linkage of a tractor; at the second end, a three point linkage for attachment to three point hitch points of a secondary implement, the three point linkage welded or mechanically fastened to the frame so as to support the weight of and use of a secondary implement, and the three point linkage comprising a length-adjustable upper link and two length-adjustable lower links, each lower link connected to a stabilising bar to restrict lateral movement in use; a power take-off extension extending from the first end to the second end to enable transfer of rotational force from the power take off of the tractor through to the secondary implement, the power take off extension comprising a housing, and a male attachment at each end for connection to power take off shafts at each end for connection to at the first end, the tractor power take-off via a first PTO drive shaft attachment and at the second end the secondary implement power take off receiver via a second PTO drive shaft attachment; at least one hydraulic hose to transfer hydraulic power from the first end to the second end of the primary implement and a hydraulic plug for attachment of hydraulic hoses thereto at the first end and the second end; three point hitch point adjustment means to raise or lower the point of attachment of the three point hitch at the first end relative to the primary implement; three point linkage adjustment means to raise or lower the point of attachment of the three point linkage at the second end of the apparatus relative to the primary implement.

In another aspect of the invention, there is provided an apparatus for attachment to a utility tractor, the apparatus having a first end and a second end and comprising: a frame; a primary implement; at the first end, an upper hitch point and two lower hitch points for connecting to the three point linkage of a tractor; at the second end, a three point linkage for attachment to three point hitch points of a secondary implement, the three point linkage welded or mechanically fastened to the frame so as to support the weight of and use of a secondary implement, and the three point linkage comprising a length-adjustable upper link and two length-adjustable lower links, each lower link connected to a stabilising bar to restrict lateral movement in use and each lower link connected to a lift rod; at the second end, a hydraulic mechanism to raise or lower the lift rods connected to the lower links and thereby raise or lower the primary implement three point linkage; a power take-off extension extending from the first end to the second end to enable transfer of rotational force from the power take off of the tractor through to the secondary implement, the power take off extension comprising a housing, and a male attachment at each end for connection to power take off shafts at each end for connection to at the first end, the tractor power take-off via a first PTO drive shaft attachment and at the second end the secondary implement power take off receiver via a second PTO drive shaft attachment; at least one hydraulic hose to transfer hydraulic power from the first end to the second end of the primary implement and a hydraulic plug for attachment of hydraulic hoses thereto at the first end and the second end; three point hitch point adjustment means to raise or lower the point of attachment of the three point hitch at the first end relative to the primary implement; three point linkage adjustment means to raise or lower the point of attachment of the three point linkage at the second end of the apparatus relative to the primary implement.

Another aspect of the invention provides an apparatus for attachment to a utility tractor, the apparatus having a first end and a second end and comprising: a frame; a primary implement; at the first end, an upper hitch point and two lower hitch points for connecting to the three point linkage of a tractor; at the second end, a three point linkage for attachment to three point hitch points of a secondary implement, the three point linkage welded or mechanically fastened to the frame so as to support the weight of and use of a secondary implement, and the three point linkage comprising a length-adjustable upper link and two length-adjustable lower links, each lower link connected to a stabilising bar to restrict lateral movement in use and each lower link connected to a lift rod; at the second end, a hydraulic mechanism to raise or lower the lift rods connected to the lower links and thereby raise or lower the primary implement three point linkage; a power take-off extension extending from the first end to the second end to enable transfer of rotational force from the power take off of the tractor through to the secondary implement, the power take off extension comprising a housing, and a male attachment at each end for connection to power take off shafts at each end for connection to at the first end, the tractor power take-off via a first PTO drive shaft attachment and at the second end the secondary implement power take off receiver via a second PTO drive shaft attachment; at least one hydraulic hose to transfer hydraulic power from the first end to the second end of the primary implement and a hydraulic plug for attachment of hydraulic hoses thereto at the first end and the second end; three point hitch point adjustment means to raise or lower the point of attachment of the three point hitch at the first end relative to the primary implement; three point linkage adjustment means to raise or lower the point of attachment of the three point linkage at the second end of the apparatus relative to the primary implement; wherein the vertical convergence is at least 0.9 times the tractor wheelbase.

In yet another aspect, the invention provides an apparatus for attachment to a utility tractor, the apparatus having a first end and a second end and comprising: a frame; a primary implement; at the first end, an upper hitch point and two lower hitch points for connecting to the three point linkage of a tractor; at the second end, a three point linkage for attachment to three point hitch points of a secondary implement, the three point linkage welded or mechanically fastened to the frame so as to support the weight of and use of a secondary implement, and the three point linkage comprising a length-adjustable upper link and two length-adjustable lower links, each lower link connected to a stabilising bar to restrict lateral movement in use and each lower link connected to a lift rod; at the second end, a hydraulic mechanism to raise or lower the lift rods connected to the lower links and thereby raise or lower the primary implement three point linkage; a power take-off extension extending from the first end to the second end to enable transfer of rotational force from the power take off of the tractor through to the secondary implement, the power take off extension comprising a housing, and a male attachment at each end for connection to power take off shafts at each end for connection to at the first end, the tractor power take-off via a first PTO drive shaft attachment and at the second end the secondary implement power take off receiver via a second PTO drive shaft attachment; at least one hydraulic hose to transfer hydraulic power from the first end to the second end of the primary implement and a hydraulic plug for attachment of hydraulic hoses thereto at the first end and the second end; three point hitch point adjustment means to raise or lower the point of attachment of the three point hitch at the first end relative to the primary implement; three point linkage adjustment means to raise or lower the point of attachment of the three point linkage at the second end of the apparatus relative to the primary implement; wherein the horizontal convergence distance is selected from 1700 mm to 2400 mm for category 1 and 1N hitches, 1800 mm to 2400 mm for category 2, 2N and 3N hitches, 1900 to 2700 mm for category 3 hitches, 1900 to 2700 mm for category 4N hitches and 1900 to 2800 mm for category 4 hitches; and wherein the vertical convergence is at least 0.9 times the tractor wheelbase.

Another aspect of the invention provides an apparatus for attachment to a utility tractor, the apparatus having a first end and a second end and comprising: a frame; a primary implement; at the first end, an upper hitch point and two lower hitch points for connecting to the three point linkage of a tractor; at the second end, a three point linkage for attachment to three point hitch points of a secondary implement, the three point linkage welded or mechanically fastened to the frame so as to support the weight of and use of a secondary implement, and the three point linkage comprising a length-adjustable upper link and two length-adjustable lower links, each lower link connected to a stabilising bar to restrict lateral movement in use and each lower link connected to a lift rod; at the second end, a hydraulic mechanism to raise or lower the lift rods connected to the lower links and thereby raise or lower the primary implement three point linkage; a power take-off extension extending from the first end to the second end to enable transfer of rotational force from the power take off of the tractor through to the secondary implement, the power take off extension comprising a housing, and a male attachment at each end for connection to power take off shafts at each end for connection to at the first end, the tractor power take-off via a first PTO drive shaft attachment and at the second end the secondary implement power take off receiver via a second PTO drive shaft attachment; at least one hydraulic hose to transfer hydraulic power from the first end to the second end of the primary implement and a hydraulic plug for attachment of hydraulic hoses thereto at the first end and the second end; three point hitch point adjustment means to raise or lower the point of attachment of the three point hitch at the first end relative to the primary implement; three point linkage adjustment means to raise or lower the point of attachment of the three point linkage at the second end of the apparatus relative to the primary implement; wherein, in relation to the three point linkage at the second end of the apparatus: the lower hitch point height is selected from: a maximum of 200 mm for category 1N and 1 hitches, and a maximum of 203 mm for category 2N, 2, 3N, 3, 4N and 4 hitches; the levelling adjustment is selected from: at least 75 mm for a category 1N hitch, at least 100 mm for category 1, 2N and 2 hitches, at least 125 mm for category 3N and 3 hitches and at least 150 mm for category 4N and 4 hitches; the movement range is selected from: at least 610 mm for category 1N and 1 hitches, at least 650 mm for category 2N and 2 hitches, at least 735 mm for category 3N and 3 hitches, and at least 760 mm for category 4N and 4 hitches; the transport height is selected from: at least 600 mm for a category 1N hitch, at least 820 mm for a category 1 hitch, at least 950 mm for category 2N and 2 hitches, at least 1065 mm for category 3N and 3 hitches and at least 1200 mm for category 4N and 4 hitches; the lower hitch point clearance is selected from at least 90 mm for a category 1 hitch, and 100 mm for category 1, 2N, 2, 3N, 3, 4N, and 4 hitches; the mast adjustment height is selected from: for a category 1N hitch a lowest position of no more than 200 mm and a highest position of at least 420 mm, for a category 1 hitch, a lowest position of no more than 200 mm and a highest position of at least 508 mm, for category 2N and 2 hitches, a lowest position of no more than 200 mm and a highest position of at least 610 mm, for category 3N and 3 hitches, a lowest position of no more than 230 mm and a highest position of at least 660 mm, for category 4N and 4 hitches, a lowest position of no more than 255 mm and a highest position of at least 710 mm; the torsional free float is selected from: at least 60 mm for category 1N, 1, 2N and 2 hitches and at least 75 mm for category 3N, 3, 4N and 4 hitches; transport pitches in the range −3° to +3° and +10° to +15° at the standard mast height; the distance from the end of the power take-off to the centre of the lower hitch point, with the lower link horizontal is selected from: for a 35 mm PTO shaft, for a category 1N hitch in the range 300 to 375 mm, for a category 1 hitch in the range 500 to 575 mm, for categories 2N and 2 hitches, in the range 510 to 675 mm, for category 3N or 3 hitches, preferably in the range 560 to 725 mm; for a 45 mm PTO shaft, for category 2N or 2 hitches, in the range 590 to 725 mm, for category 3N or 3 hitches, in the range 640 to 775 mm, for category 4N or 4 hitches in the range 650 to 875 mm; the lateral movement of the lower hitch point selected from: for category 1N hitch in the range 50 to 55 mm, for category 1 or 2N hitches in the range 100 to 110 mm, for category 2, 3N, 3, 4N and 4 hitches in the range 125 to 138 mm; wherein the horizontal convergence distance is selected from 1700 mm to 2400 mm for category 1 and 1N hitches, 1800 mm to 2400 mm for category 2, 2N and 3N hitches, 1900 to 2700 mm for category 3 hitches, 1900 to 2700 mm for category 4N hitches and 1900 to 2800 mm for category 4 hitches; and wherein the vertical convergence is at least 0.9 times the tractor wheelbase.

In another aspect, the invention provides an apparatus for attachment to a utility tractor, the apparatus having a first end and a second end and comprising: a frame; a primary implement comprising a platform for carrying agricultural tools or equipment, the platform comprising a toolbox welded or mechanically fixed thereto; the apparatus comprising at the first end, an upper hitch point and two lower hitch points for connecting to the three point linkage of a tractor; at the second end, a three point linkage for attachment to three point hitch points of a secondary implement, the three point linkage welded or mechanically fastened to the frame so as to support the weight of and use of a secondary implement, and the three point linkage comprising a length-adjustable upper link and two length-adjustable lower links, each lower link connected to a stabilising bar to restrict lateral movement in use; a power take-off extension extending from the first end to the second end to enable transfer of rotational force from the power take off of the tractor through to the secondary implement, the power take off extension comprising a housing, and a male attachment at each end for connection to power take off shafts at each end for connection to at the first end, the tractor power take-off via a first PTO drive shaft attachment and at the second end the secondary implement power take off receiver via a second PTO drive shaft attachment; at least one hydraulic hose to transfer hydraulic power from the first end to the second end of the primary implement and a hydraulic plug for attachment of hydraulic hoses thereto at the first end and the second end; three point hitch point adjustment means to raise or lower the point of attachment of the three point hitch at the first end relative to the primary implement; three point linkage adjustment means to raise or lower the point of attachment of the three point linkage at the second end of the apparatus relative to the primary implement; wherein, in relation to the three point linkage at the second end of the apparatus: the lower hitch point height is selected from: a maximum of 200 mm for category 1N and 1 hitches, and a maximum of 203 mm for category 2N, 2, 3N, 3, 4N and 4 hitches; the torsional free float is selected from: at least 60 mm for category 1N, 1, 2N and 2 hitches and at least 75 mm for category 3N, 3, 4N and 4 hitches; transport pitches in the range −3° to +3° and +10° to +15° at the standard mast height; the distance from the end of the power take-off to the centre of the lower hitch point, with the lower link horizontal is selected from: for a 35 mm PTO shaft, for a category 1N hitch in the range 300 to 375 mm, for a category 1 hitch in the range 500 to 575 mm, for categories 2N and 2 hitches, in the range 510 to 675 mm, for category 3N or 3 hitches, preferably in the range 560 to 725 mm; for a 45 mm PTO shaft, for category 2N or 2 hitches, in the range 590 to 725 mm, for category 3N or 3 hitches, in the range 640 to 775 mm, for category 4N or 4 hitches in the range 650 to 875 mm; the lateral movement of the lower hitch point selected from: for category 1N hitch in the range 50 to 55 mm, for category 1 or 2N hitches in the range 100 to 110 mm, for category 2, 3N, 3, 4N and 4 hitches in the range 125 to 138 mm; wherein the horizontal convergence distance is selected from 1700 mm to 2400 mm for category 1 and 1N hitches, 1800 mm to 2400 mm for category 2, 2N and 3N hitches, 1900 to 2700 mm for category 3 hitches, 1900 to 2700 mm for category 4N hitches and 1900 to 2800 mm for category 4 hitches; and wherein the vertical convergence is at least 0.9 times the tractor wheelbase.

In a further aspect of the invention, there is provided an apparatus for attachment to a utility tractor, the apparatus having a first end and a second end and comprising: a frame; a primary implement comprising a platform for carrying agricultural tools or equipment, the platform comprising a toolbox welded or mechanically fixed thereto; the apparatus comprising at the first end, an upper hitch point and two lower hitch points for connecting to the three point linkage of a tractor; at the second end, a three point linkage for attachment to three point hitch points of a secondary implement, the three point linkage welded or mechanically fastened to the frame so as to support the weight of and use of a secondary implement, and the three point linkage comprising a length-adjustable upper link and two length-adjustable lower links, each lower link connected to a stabilising bar to restrict lateral movement in use and each lower link connected to a lift rod; at the second end, a hydraulic mechanism to raise or lower the lift rods connected to the lower links and thereby raise or lower the primary implement three point linkage; a power take-off extension extending from the first end to the second end to enable transfer of rotational force from the power take off of the tractor through to the secondary implement, the power take off extension comprising a housing, and a male attachment at each end for connection to power take off shafts at each end for connection to at the first end, the tractor power take-off via a first PTO drive shaft attachment and at the second end the secondary implement power take off receiver via a second PTO drive shaft attachment; at least one hydraulic hose to transfer hydraulic power from the first end to the second end of the primary implement and a hydraulic plug for attachment of hydraulic hoses thereto at the first end and the second end; three point hitch point adjustment means to raise or lower the point of attachment of the three point hitch at the first end relative to the primary implement; three point linkage adjustment means to raise or lower the point of attachment of the three point linkage at the second end of the apparatus relative to the primary implement; wherein, in relation to the three point linkage at the second end of the apparatus: the lower hitch point height is selected from: a maximum of 200 mm for category 1N and 1 hitches, and a maximum of 203 mm for category 2N, 2, 3N, 3, 4N and 4 hitches; the levelling adjustment is selected from: at least 75 mm for a category 1N hitch, at least 100 mm for category 1, 2N and 2 hitches, at least 125 mm for category 3N and 3 hitches and at least 150 mm for category 4N and 4 hitches; the movement range is selected from: at least 610 mm for category 1N and 1 hitches, at least 650 mm for category 2N and 2 hitches, at least 735 mm for category 3N and 3 hitches, and at least 760 mm for category 4N and 4 hitches; the transport height is selected from: at least 600 mm for a category 1N hitch, at least 820 mm for a category 1 hitch, at least 950 mm for category 2N and 2 hitches, at least 1065 mm for category 3N and 3 hitches and at least 1200 mm for category 4N and 4 hitches; the lower hitch point clearance is selected from at least 90 mm for a category 1 hitch, and 100 mm for category 1, 2N, 2, 3N, 3, 4N, and 4 hitches; the mast adjustment height is selected from: for a category 1N hitch a lowest position of no more than 200 mm and a highest position of at least 420 mm, for a category 1 hitch, a lowest position of no more than 200 mm and a highest position of at least 508 mm, for category 2N and 2 hitches, a lowest position of no more than 200 mm and a highest position of at least 610 mm, for category 3N and 3 hitches, a lowest position of no more than 230 mm and a highest position of at least 660 mm, for category 4N and 4 hitches, a lowest position of no more than 255 mm and a highest position of at least 710 mm; the torsional free float is selected from: at least 60 mm for category 1N, 1, 2N and 2 hitches and at least 75 mm for category 3N, 3, 4N and 4 hitches; transport pitches in the range −3° to +3° and +10° to +15° at the standard mast height; the distance from the end of the power take-off to the centre of the lower hitch point, with the lower link horizontal is selected from: for a 35 mm PTO shaft, for a category 1N hitch in the range 300 to 375 mm, for a category 1 hitch in the range 500 to 575 mm, for categories 2N and 2 hitches, in the range 510 to 675 mm, for category 3N or 3 hitches, preferably in the range 560 to 725 mm; for a 45 mm PTO shaft, for category 2N or 2 hitches, in the range 590 to 725 mm, for category 3N or 3 hitches, in the range 640 to 775 mm, for category 4N or 4 hitches in the range 650 to 875 mm; the lateral movement of the lower hitch point selected from: for category 1N hitch in the range 50 to 55 mm, for category 1 or 2N hitches in the range 100 to 110 mm, for category 2, 3N, 3, 4N and 4 hitches in the range 125 to 138 mm wherein the horizontal convergence distance is selected from 1700 mm to 2400 mm for category 1 and 1N hitches, 1800 mm to 2400 mm for category 2, 2N and 3N hitches, 1900 to 2700 mm for category 3 hitches, 1900 to 2700 mm for category 4N hitches and 1900 to 2800 mm for category 4 hitches; and wherein the vertical convergence is at least 0.9 times the tractor wheelbase.

In another aspect, the invention provides an apparatus for attachment to a utility tractor, the apparatus having a first end and a second end and comprising: a frame; a primary implement selected from a grader blade, a bed former, a box blade scraper, a dirt scoop, harrows, a ripper, a rotary hoe, a plough, landscape rakes, an s-tine cultivator, and a tillage implement; the apparatus comprising at the first end, an upper hitch point and two lower hitch points for connecting to the three point linkage of a tractor; at the second end, a three point linkage for attachment to three point hitch points of a secondary implement, the three point linkage welded or mechanically fastened to the frame so as to support the weight of and use of a secondary implement, and the three point linkage comprising a length-adjustable upper link and two length-adjustable lower links, each lower link connected to a stabilising bar to restrict lateral movement in use and each lower link connected to a lift rod; at the second end, a hydraulic mechanism to raise or lower the lift rods connected to the lower links and thereby raise or lower the primary implement three point linkage; a power take-off extension extending from the first end to the second end to enable transfer of rotational force from the power take off of the tractor through to the secondary implement, the power take off extension comprising a housing, and a male attachment at each end for connection to power take off shafts at each end for connection to at the first end, the tractor power take-off via a first PTO drive shaft attachment and at the second end the secondary implement power take off receiver via a second PTO drive shaft attachment; at least one hydraulic hose to transfer hydraulic power from the first end to the second end of the primary implement and a hydraulic plug for attachment of hydraulic hoses thereto at the first end and the second end; three point hitch point adjustment means to raise or lower the point of attachment of the three point hitch at the first end relative to the primary implement; three point linkage adjustment means to raise or lower the point of attachment of the three point linkage at the second end of the apparatus relative to the primary implement; wherein, in relation to the three point linkage at the second end of the apparatus: the lower hitch point height is selected from: a maximum of 200 mm for category 1N and 1 hitches, and a maximum of 203 mm for category 2N, 2, 3N, 3, 4N and 4 hitches; the levelling adjustment is selected from: at least 75 mm for a category 1N hitch, at least 100 mm for category 1, 2N and 2 hitches, at least 125 mm for category 3N and 3 hitches and at least 150 mm for category 4N and 4 hitches; the movement range is selected from: at least 610 mm for category 1N and 1 hitches, at least 650 mm for category 2N and 2 hitches, at least 735 mm for category 3N and 3 hitches, and at least 760 mm for category 4N and 4 hitches; the transport height is selected from: at least 600 mm for a category 1N hitch, at least 820 mm for a category 1 hitch, at least 950 mm for category 2N and 2 hitches, at least 1065 mm for category 3N and 3 hitches and at least 1200 mm for category 4N and 4 hitches; the lower hitch point clearance is selected from at least 90 mm for a category 1 hitch, and 100 mm for category 1, 2N, 2, 3N, 3, 4N, and 4 hitches; the mast adjustment height is selected from: for a category 1N hitch a lowest position of no more than 200 mm and a highest position of at least 420 mm, for a category 1 hitch, a lowest position of no more than 200 mm and a highest position of at least 508 mm, for category 2N and 2 hitches, a lowest position of no more than 200 mm and a highest position of at least 610 mm, for category 3N and 3 hitches, a lowest position of no more than 230 mm and a highest position of at least 660 mm, for category 4N and 4 hitches, a lowest position of no more than 255 mm and a highest position of at least 710 mm; the torsional free float is selected from: at least 60 mm for category 1N, 1, 2N and 2 hitches and at least 75 mm for category 3N, 3, 4N and 4 hitches; transport pitches in the range −3° to +3° and +10° to +15° at the standard mast height; the distance from the end of the power take-off to the centre of the lower hitch point, with the lower link horizontal is selected from: for a 35 mm PTO shaft, for a category 1N hitch in the range 300 to 375 mm, for a category 1 hitch in the range 500 to 575 mm, for categories 2N and 2 hitches, in the range 510 to 675 mm, for category 3N or 3 hitches, preferably in the range 560 to 725 mm; for a 45 mm PTO shaft, for category 2N or 2 hitches, in the range 590 to 725 mm, for category 3N or 3 hitches, in the range 640 to 775 mm, for category 4N or 4 hitches in the range 650 to 875 mm; the lateral movement of the lower hitch point selected from: for category 1N hitch in the range 50 to 55 mm, for category 1 or 2N hitches in the range 100 to 110 mm, for category 2, 3N, 3, 4N and 4 hitches in the range 125 to 138 mm; wherein the horizontal convergence distance is selected from 1700 mm to 2400 mm for category 1 and 1N hitches, 1800 mm to 2400 mm for category 2, 2N and 3N hitches, 1900 to 2700 mm for category 3 hitches, 1900 to 2700 mm for category 4N hitches and 1900 to 2800 mm for category 4 hitches; and wherein the vertical convergence is at least 0.9 times the tractor wheelbase.

In some embodiments, the vertical convergence is at least the same length as the tractor wheelbase.

What is claimed is:

1.-20. (canceled)

21. An apparatus for attachment to a tractor, the apparatus comprising: a primary implement and at a first end, a first connection suitable to connect to a three point linkage of the tractor and at a second end, a second connection suitable to connect to three point hitch points of a secondary implement.

22. An apparatus according to claim 1, wherein the primary implement comprises a platform for carrying agricultural tools or equipment.

23. An apparatus according to claim 1, wherein the primary implement is selected from a grader blade, a bed former, a box blade scraper, a dirt scoop, harrows, a ripper, a rotary hoe, a plough, landscape rakes, an s-tine cultivator, and a tillage implement.

24. An apparatus according to claim 1, wherein the upper link and two lower links are length adjustable.

25. An apparatus according to claim 1, further comprising a power take-off extension extending from the first end to the second end of the apparatus to enable transfer of rotational force from the power take-off of the tractor through to the secondary implement, the power take off extension comprising a housing, and an attachment at each end for connection to, at the first end, the tractor power take-off and at the second end the secondary implement power take off receiver.

26. An apparatus according to claim 25, wherein the power take-off extension is located underneath the primary implement.

27. An apparatus according to claim 1, wherein each lower link is connected to a stabilising bar to restrict lateral movement in use.

28. An apparatus according to claim 1, further comprising a three point linkage adjustment means to raise or lower the point of attachment of the three point linkage at the second end of the apparatus relative to the primary implement.

29. An apparatus according to claim 1, further comprising a three point hitch point adjustment means to raise or lower the point of attachment of the three point hitch points at the first end of the apparatus relative to the primary implement.

30. An apparatus according to claim 1, further comprising at least one hydraulic hose to transfer hydraulic power from the first end to the second end of the apparatus and hydraulic plugs for attachment of hydraulic hoses thereto at the first end and the second end.

31. An apparatus according to claim 1, wherein each lower link is connected to a lift rod.

32. An apparatus according to claim 1, wherein the horizontal convergence distance is selected from 1700 mm to 2400 mm for category 1 and 1N hitches, 1800 mm to 2400 mm for category 2, 2N and 3N hitches, 1900 to 2700 mm for category 3 hitches, 1900 to 2700 mm for category 4N hitches and 1900 to 2800 mm for category 4 hitches.

33. An apparatus according to claim 1, wherein, in relation to the three point linkage at the second end of the apparatus:
the lower hitch point height is selected from: a maximum of 200 mm for category 1N and 1 hitches, and a maximum of 203 mm for category 2N, 2, 3N, 3, 4N and 4 hitches;
the levelling adjustment is selected from: at least 75 mm for a category 1N hitch, at least 100 mm for category 1, 2N and 2 hitches, at least 125 mm for category 3N and 3 hitches and at least 150 mm for category 4N and 4 hitches;
the movement range is selected from: at least 610 mm for category 1N and 1 hitches, at least 650 mm for category 2N and 2 hitches, at least 735 mm for category 3N and 3 hitches, and at least 760 mm for category 4N and 4 hitches;
the transport height is selected from: at least 600 mm for a category 1N hitch, at least 820 mm for a category 1 hitch, at least 950 mm for category 2N and 2 hitches, at least 1065 mm for category 3N and 3 hitches and at least 1200 mm for category 4N and 4 hitches;
the lower hitch point clearance is selected from at least 90 mm for a category 1 hitch, and 100 mm for category 1, 2N, 2, 3N, 3, 4N, and 4 hitches;
the mast adjustment height is selected from: for a category 1N hitch a lowest position of no more than 200 mm and a highest position of at least 420 mm, for a category 1 hitch, a lowest position of no more than 200 mm and a highest position of at least 508 mm, for category 2N and 2 hitches, a lowest position of no more than 200 mm and a highest position of at least 610 mm, for category 3N and 3 hitches, a lowest position of no more than 230 mm and a highest position of at least 660 mm, for category 4N and 4 hitches, a lowest position of no more than 255 mm and a highest position of at least 710 mm;
the torsional free float is selected from: at least 60 mm for category 1N, 1, 2N and 2 hitches and at least 75 mm for category 3N, 3, 4N and 4 hitches;
transport pitches in the range −3° to +3° and +10° to +15° at the standard mast height;
the distance from the end of the power take-off to the centre of the lower hitch point, with the lower link horizontal is selected from:
for a 35 mm PTO shaft, for a category 1N hitch in the range 300 to 375 mm, for a category 1 hitch in the range 500 to 575 mm, for categories 2N and 2 hitches, in the range 510 to 675 mm, for category 3N or 3 hitches, preferably in the range 560 to 725 mm;
for a 45 mm PTO shaft, for category 2N or 2 hitches, in the range 590 to 725 mm, for category 3N or 3 hitches, in the range 640 to 775 mm, for category 4N or 4 hitches in the range 650 to 875 mm;
the lateral movement of the lower hitch point selected from: for category 1N hitch in the range 50 to 55 mm, for category 1 or 2N hitches in the range 100 to 110 mm, for category 2, 3N, 3, 4N and 4 hitches in the range 125 to 138 mm
wherein the horizontal convergence distance is selected from 1700 mm to 2400 mm for category 1 and 1N hitches, 1800 mm to 2400 mm for category 2, 2N and 3N hitches, 1900 to 2700 mm for category 3 hitches, 1900 to 2700 mm for category 4N hitches and 1900 to 2800 mm for category 4 hitches; and
wherein the vertical convergence is at least 0.9 times the tractor wheelbase.

34. An apparatus according to claim 1, wherein the vertical convergence is at least 0.9 times the tractor wheelbase.

35. An apparatus according to claim 1, wherein the vertical convergence is at least the same length as the tractor wheelbase.

36. An apparatus according to claim 1, further comprising a stabiliser which comprises one or more of a wheel or a stand or one or more legs.

37. An apparatus according to claim 36, wherein the stabiliser is releasably fixed to the underside so that it can be removed when not required.

38. An apparatus according to claim 36, wherein the stabiliser comprises a hinge mechanism so that it is able to be folded up out of the way.

39. A kit of parts for retrofitting to a primary implement to manufacture an apparatus for attachment to a tractor, the kit comprising: an upper link, two lower links, two side stabiliser bars, and a housing comprising a PTO extension and attachment points for attachment of the housing to a frame of the primary implement.

40. An apparatus for attachment to a utility tractor, the apparatus having a first end and a second end and comprising:
a frame;
a primary implement;
at the first end, an upper hitch point and two lower hitch points for connecting to a three point linkage of a tractor;
at the second end, a three point linkage for attachment to three point hitch points of a secondary implement, the three point linkage welded or mechanically fastened to the frame so as to support the weight of and use of a secondary implement, and the three point linkage comprising an upper link and two lower links.
